(19) United States
(12) Patent Application Publication
(10) Pub. No.: US 2022/0263240 A1
(43) Pub. Date: Aug. 18, 2022

(54) Interference aware adaption of antenna radiation patterns

(71) Applicant: Fraunhofer-Gesellschaft zur Foerderung der angewandten Forschung e.V., Munich (DE)

(72) Inventors: Paul Simon Holt LEATHER, Berlin-Schlachtensee (DE); Thomas HAUSTEIN, Berlin (DE); Mathis SCHMIEDER, Berlin (DE)

(21) Appl. No.: 17/662,173

(22) Filed: May 5, 2022

Related U.S. Application Data
(63) Continuation of application No. PCT/EP2020/081036, filed on Nov. 5, 2020.

(30) Foreign Application Priority Data
Nov. 7, 2019 (EP) 19207744.4

(51) Int. Cl. H01Q 3/26; H01Q 15/00

(52) U.S. Cl. CPC H01Q 3/2623; H01Q 15/0053

(57) ABSTRACT

A device configured for operating in a wireless communication network is configured for forming an antenna radiation pattern for communicating with a communication partner. The antenna radiation pattern includes a main lobe and side lobes. The device is configured for controlling the main lobe towards a path to the communication partner; and to control the side lobes to address interference at the location of a further device.

### CROSS-REFERENCES TO RELATED APPLICATIONS

This application is a continuation of copending International Application No. PCT/EP2020/081036, filed Nov. 5, 2020, which is incorporated herein by reference in its entirety, and additionally claims priority from European Application No. EP 19 207 744.4, filed Nov. 7, 2019, which is incorporated herein by reference in its entirety.

The present invention relates to devices for communicating in wireless communication networks, to wireless communication networks and to methods for operating the same. The present invention further relates to an interference aware adaptation of antenna radiation patterns and to an assessment of antenna pattern characteristics using network devices.

### BACKGROUND OF THE INVENTION

In the following, a short description of certain cellular radio principles is given.

Given that a fixed amount of radio spectrum is available for the prevision of a certain service—for example, enhanced mobile broadband and personal communication services—the system designer has to balance the apparently conflicting requirements of area coverage and system capacity. Cellular schemes, which not only address these constraints but have also become widespread and highly-developed commercial successes, have used the principle of frequency-reuse. In a cellular network, each cell has its own relatively low-power basestation transmitter and is assigned a radio channel such that some distance away from that cell, the same radio channel can be re-assigned to another cell. On the other hand, adjacent cells, which are not separated in distance, are assigned different radio channels. While the advantage of frequency-reuse should now be clear, there is however a disadvantage. Since the total available spectrum is divided into smaller radio channels that are reused, the bandwidth available within any single cell is reduced and so too is its capacity and throughput.

### Frequency Re-Use Schemes

The design and development of a cellular radio communication network is largely dependent on whether its performance is either more limited by noise (typically due to thermal effects in both active and passive electronic components) or is more limited by the interference created by other devices operating in the network.

Frequency reuse schemes have been proposed to improve spectral efficiency and signal quality. The different schemes provide different trade-offs between resource utilization and quality of service (QoS). The classical reuse-3 (N=3) scheme proposed for GSM systems offers a protection against intercell interference. However, only a third of the spectral resources are used within each cell. In the reuse-1 scheme in which all the resources are used in every cell (N=1), interference at the cell edge may be critical [2]. The situation is better for N>1 used in 2G networks (such as GSM or AMPS) because the co-channel interferers are physically located farther apart from each other due to the frequency reuse distance. For networks where N=1 and, since every cell is an interferer, the situation is worst. “Pilot pollution” (or “no dominant server”) describes a situation where, at a given location, there is insignificant difference in the power received from many different cells. As a result, the composite signal level is high, but the SINR from any single cell is poor because the total interference is high. The result is poor RF performance even with a high overall signal level [2].

Identifying in which regime a network operates is central to the design of the system, the medium access control (MAC) and the physical-layer procedures. For example, while interference limited networks can benefit from advanced techniques such as inter-cellular interference coordination, coordinated beamforming and dynamic orthogonalization, these techniques have little value in networks where thermal noise, rather than interference, is dominant [1].

### Cell-Edge Performance

Vehicles moving at high speed may be subject to much worse cell-edge SINR due to a “handover dragging effect.” Essentially, this is caused by the fact that a fast-moving UE (user equipment) cannot always be served by the best server, because handover is not triggered until the UE has moved across the cell border, and there is a time lapse while handover completes [2]. Similar effects can be experienced in satellite-based systems such as those considered in non-terrestrial networks (NTN) which is currently an on-going study item within 3GPP 5G standardization.

A common problem near the cell edge is that the SINR from the best server is already very poor, and the SINR values from the second- and third-best servers are even worse. 3GPP simulations typically only show the SINR distribution from the best server. However, in real-life situations, the UE also has to work with the second- or—third-best server, so the real-life situation is less favourable [2].

A spread-spectrum system (e.g., CDMA or UMTS) can work under largely negative SINR values because of the large processing gain, especially for low data rates; soft handoffs are also useful. However, the LTE interface cannot operate under the same negative SINR conditions, and does not support soft handoff. These cell-edge challenges are combatted by Inter-Cell Interference Coordination (ICIC). Essentially, ICIC reduces the co-channel interference cell-edge users experience from direct neighbour cells by increasing the cell-edge SINR values [2].

In OFDMA-based systems such as LTE and NR, a resource element (RE) is the smallest unit made up of 1-symbol×1-subcarrier. A resource element group (REG) is a group of four (4) consecutive resource elements (resource elements for the reference signal is not included in REG). The control channel element (CCE) is a group of nine (9) consecutive REGs. The aggregation level describes a group of ‘L’ CCEs where L can be 1, 2, 4 or 8.

A scheduler is a functional entity of a cellular network which can be used to implement CCE-based power boosting in the power domain. The CCE aggregation level can be 1, 2, 4 or 8 (CCE-1, CCE-2, CCE-4 or CCE-8) and the higher the aggregation level, the more robust it will be. However, high aggregation levels also use more PDCCH resources. Therefore, cell-centre users will use CCE-1 or CCE-2; users located somewhere in the middle of the cell will use CCE-2 or CCE-4; cell-edge users will always use CCE-8. CCE-based power boost can boost up the transmit power level on CCE-8, which can potentially increase the signal level on CCEs for cell-edge users [2].

### CCE-Based Power Boost in Cellular Scenarios

Broadly speaking, cells can be categorized in one of the following three scenarios.

In a coverage-limited environment, the cells are spaced very far apart from each other. Examples are rural and highway cells. Typically, the signal levels near the cell edges are already very low and as a result, the out-of-cell interference levels are also very low. For coverage-limited environments, the following approximation can be made:

$$SINR = \frac{S}{n + I} \approx \frac{S}{n} = SNR$$

In this case, boosting the signal power enhances “S,” and thus improves SNR since thermal noise is constant. CCE-based power boost is effective in a coverage-limited environment.

In an interference-limited environment, the cells are tightly packed. Examples include dense suburban, urban or dense urban with small cells. Typically, the cell-edge composite signal level is very high, but the out-of-cell interference level is also very high. As a result, the cell-edge SINR is still poor. For interference-limited environment, one can approximate the situation using:

$$SINR = \frac{S}{n + I} \approx \frac{S}{I} = SIR$$

In this case, CCE-based power boost will not be effective, because when signal power is boosted up, the out-of-cell interference level is also increased, and as a result the SIR is not improved. Generally, when cell-edge power level is already very high, boosting the power further will not help.

This phenomenon is the so-called “cocktail party effect:” in a cocktail party with high noise level in the background, it does not improve audibility if everyone increases their voice level; it just creates a higher level of background noise. Unfortunately, an interference-limited environment is the area where help is most needed. Call drops happen most frequently in small cells, especially calls placed from fast-moving vehicles.

In environments somewhere between interference-limited and coverage-limited, the cells are neither very close nor very far from each other. Examples are typically light suburban cells. As long as both “l” and “n” terms are not negligible in the SINR equation, boosting the signal level will help somewhat, but this is not as effective as the situation for coverage-limited environments. The degree of effectiveness depends on the magnitude of “l” versus the magnitude of “n”; the higher the ratio of l/n, the less effective it will be, and vice versa. In general, l>n, and so the main issue here is that the gain achieved from CCE-based power boost may not be sufficient to handle the worst-case scenario [2].

### Reference Signals in LTE and NR

In LTE, cell reference signals (CRS) were designed to be continuously broadcast and distributed in both the time and frequency domains across the whole carrier bandwidth. This was done to help the UE lock its time/frequency raster and to ease the decoding of downlink (DL) data. However, this requires a large number of resource elements (RE) to be transmitting CRS even when there are no users in the cell, thus wasting DL power and causing interference to neighbouring cells [3].

A later LTE development was the introduction of demodulation reference signals (DM-RS) which were used instead of CRS for the decoding of data. To limit CRS broadcasts, features such as lean carrier and pilot breathing were proposed. 5G NR is designed to have an ultra-lean physical layer, replacing continuous reference signals with on-demand ones:

Channel State Information Reference Signal (CSI-RS): Reference signal with main functionalities of CSI acquisition, beam management. CSI-RS resources for a UE is configured by RRC information elements, and can be dynamically activated/deactivated via MAC CE or DCI [3].

Demodulation Reference Signal (DMRS): Reference signals which are UE specific and could be beam formed, will be used for data and control demodulation. They are transmitted only on the PRBs upon which the corresponding PDSCH is mapped [3].

Phase Tracking Reference Signal (PTRS): A new type of reference signals is introduced, called Tracking Reference Signals, and it is used for: Time and Frequency tracking at UE side; and Estimation of delay spread and Doppler spread at UE side. It is transmitted in a confined bandwidth for a configurable period of time, controlled by upper layers parameters [3].

### Millimetre-Wave Spectrum and frequency Range Two

The millimetre-wave (mmWave) spectrum, roughly defined as the frequencies between 10 and 300 GHz, is a new and promising frontier for cellular wireless communications. The mmWave bands offer vast and largely untapped spectrum and, by some estimates, offer up to 200 times the bandwidth of all current cellular operating frequency bands. This enormous potential has identified mmWave networks as being one of the most promising technologies for 5G and Beyond 5G cellular evolution. In connection with 3GPP standardization of new radio (NR), two frequency ranges have been defined: FR1 from 410 MHz to 7,125 MHz and FR2 from 24.25 GHz to 52.6 GHz. In addition to these current definitions, 3GPP is studying additional mmWave frequency ranges: new definitions are likely. The content of the current invention disclosure is applicable to all mmWave frequencies.

Massive MIMO (mMIMO) with beamforming will be used to achieve higher network capacity and higher data throughputs in these new frequency bands. Using these technologies, however, changes the radio access from cell coverage to beam coverage, representing a significant change from 4G Radio Access Networks (RANs) [4]

### NR Radio Resource Management Measurements and FR2

Radio resource management (RRM) in NR is based on measurements of the synchronization signal block (SSB) or the CSI-RS, and can be reported with metrics such as reference signal received power (RSRP) and reference signal received quality (RSRQ). Radio link monitoring (RLM) measurement requirements for NR include both SSB based measurements and CSI-RS based measurements [5].

For SSB based measurements, the UE will conduct intra-frequency and/or inter frequency RSRP, RSRQ and RS-SINR measurements, with or without gaps. For CSI-RS based beam measurements, the UE will report the physical layer RSRP. CSI-RS based RSRP, RSRQ and RS-SINR shall also be supported [5].

From a measurement perspective, an FR2 UE can utilize an analogue and/or digital beamforming receiver. Longer measurement times are necessary in order for an FR2 UE to sweep spherically [5].

In 3GPP Rel-15, layer 1 (L1) RSRP was introduced as the metric for beam-related measurements as it reflects the absolute received power on the configured reference signal(s). However, when multi-beam transmission and reception techniques are used in practice, beam selection based on L1-RSRP alone may be insufficient [5]. It reported that multiple, spatially-adjacent beams, exhibiting the strong and similar RSRPs, may cause strong mutual interference. Such interference information should be properly evaluated as the input for beam selection [6].

To enable convenient beam-level multi-user paring, mechanisms to evaluate and report inter-beam interference have drawn recent attentions. However, the UE Rx beam information is transparent in Rel-15 beam reporting mechanism where the gNB is not aware of the association between the Tx beam and the corresponding UE Rx beam. A Rel-16 work item description thus includes the definition of L1-RSRQ and L1-SINR for beam measurement and reporting in its scope [6].

Starting from this conventional technology, there is a need to provide for a high communication throughput and wireless communication systems.

### SUMMARY

An embodiment may have a device configured for operating in a wireless communication network, wherein the device is configured for forming an antenna radiation pattern for communicating with a communication partner; wherein the antenna radiation pattern comprises a main lobe, at least one side lobe and a null between the main lobe and the side lobe; wherein the device is configured for controlling the main lobe towards a path to the communication partner; and to control a direction of the side lobe and/or to control the null to address interference at the location of a further device.

Another embodiment may have a method for operating a device in a wireless communication network, the method having the steps of: forming an antenna radiation pattern for communicating with a communication partner, such that the antenna radiation pattern comprises a main lobe and, at least one side lobe and a null between the main lobe and the side lobe; controlling the main lobe towards a path to the communication partner; controlling a direction of the side lobe and/or controlling the null to address interference at the location of a further device.

Another embodiment may have a non-transitory digital storage medium having a computer program stored thereon to perform the method for operating a device in a wireless communication network, the method having the steps of: forming an antenna radiation pattern for communicating with a communication partner, such that the antenna radiation pattern comprises a main lobe and, at least one side lobe and a null between the main lobe and the side lobe; controlling the main lobe towards a path to the communication partner; controlling a direction of the side lobe and/or controlling the null to address interference at the location of a further device, when said computer program is run by a computer.

The inventors have found that by specifically addressing interference caused by communicating between devices at a location of other devices not involved in the communication the communication of those other devices may remain undisturbed or may be disturbed at a low level, thereby avoiding losses in communication throughput at those other devices. The inventors have found that such considerations are particularly effective at devices that are capital of performing beamforming techniques by controlling sidelobes of an antenna radiation pattern.

According to an embodiment, a device configured for operating in a wireless communication network is configured for forming an antenna radiation pattern for communicating with a communication partner. The antenna radiation pattern comprises a main lobe and sidelobes. The device is configured for controlling the main lobe towards a path to the communication partner and to control the sidelobes to address interference at the location of a further device. This allows to maintain the communication with the communication partner whilst addressing the interference at the further device so as to avoid a disturbance at its location.

According to an embodiment, a device configured for operating in a wireless communication network is configured for forming an antenna radiation pattern for communicating with a communication partner. This device may be interfered or disturbed by another device and may be configured for determining a measure of interference associated with this further device not communicating with the device. The device may be configured for reporting, to the further device or a member of a communication network in which the further device operates about the reception of power and/or interference from the further device. This allows to provide for a source of information at the interfering device to enable the interfering device to reduce the interference caused by it at the location of the interfered device.

According to an embodiment, a wireless communication network comprises at least one interfering device being configured to address interference by controlling sidelobes of its antenna radiation pattern and comprising at least one interfered device being configured to report about a received interference. Such a network may be formed as a classical communication network, in which the interfering device and the interfered device are commonly served, e.g., in a common cell of a wireless communication network being operating by an operator or in difference cells of this network. However, the described embodiment is not limited hereto but also refers to a wireless communication network that is formed by individual networks or parts thereof, e.g., cells operated by different operators or networks operating according to different standards.

Further embodiments relate to methods for operating devices described herein, methods for operating a network and to a computer program product.

### BRIEF DESCRIPTION OF THE DRAWINGS

Embodiments of the present invention will be detailed subsequently referring to the appended drawings, in which:

FIG. 1 shows an example of an idealized antenna radiation pattern plotted using perpendicular axes having an azimuth angle in degrees at the abscissa and a directivity at the ordinate;

FIG. 2 shows a schematic diagram of the antenna radiation pattern of FIG. 1 being plotted using a polar coordinate system;

FIG. 3a shows a schematic top view of at least a part of a network according to an embodiment in which an interfering device according to an embodiment is operating;

FIG. 3b shows a schematic block diagram of the part of the wireless communication network according to FIG. 3a in which the interfering device has adapted its antenna radiation pattern in view of a transmission power of sidelobes;

FIG. 3c shows a schematic block diagram of the part of the network according to FIG. 3a in which the interfering device controls a direction of the sidelobes so as to point along a different direction;

FIG. 3d shows a schematic block diagram of the scenario of FIG. 3a in which the interfering device controls the power/sensitivity and the direction of sidelobes;

FIG. 4a shows a schematic block diagram of an interfered device according to an embodiment; and

FIG. 4b shows a schematic block diagram of an interaction between the interfered device and an interfering interferer.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to antenna radiation patterns or beam patterns that are formed by a device. Such antenna radiation patterns may be transmission radiation patterns and/or reception radiation patterns, i.e., spatial patterns or advantageous directions for transmission and/or reception of a signal. Such an antenna radiation pattern may comprise a main lobe (optionally additional main lobes) and one or more sidelobes. Between two adjacent lobes, there may be arranged a so-called null. As described in connection with the millimetre-wave spectrum, the use of millimetre-wave frequencies creates a paradigm change for cellular radio networks as the principle of coverage may move away from that of cell coverage to that of beam coverage instead. Although 3G PP NR defines beam management procedures and beam correspondence requirements [7], embodiments relate to the beam part of the antenna radiation pattern.

### Antenna Directivity

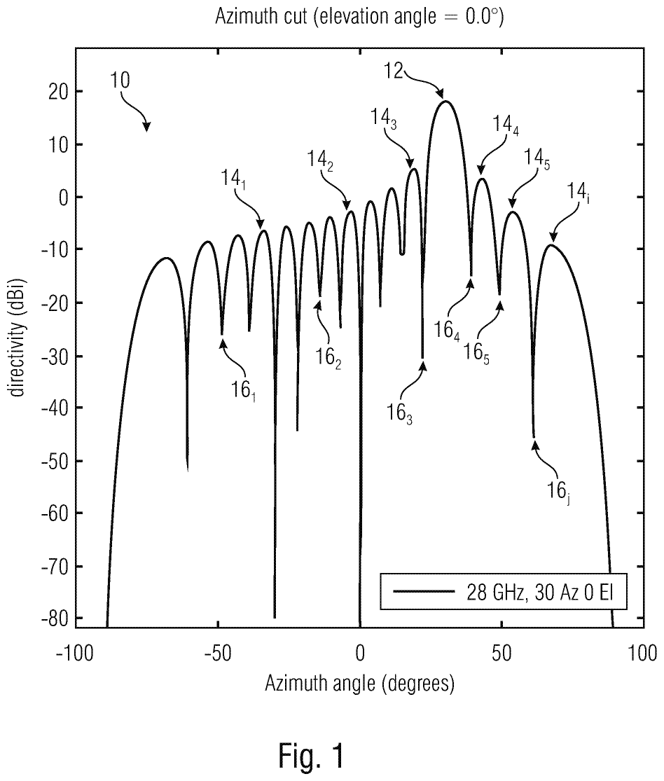

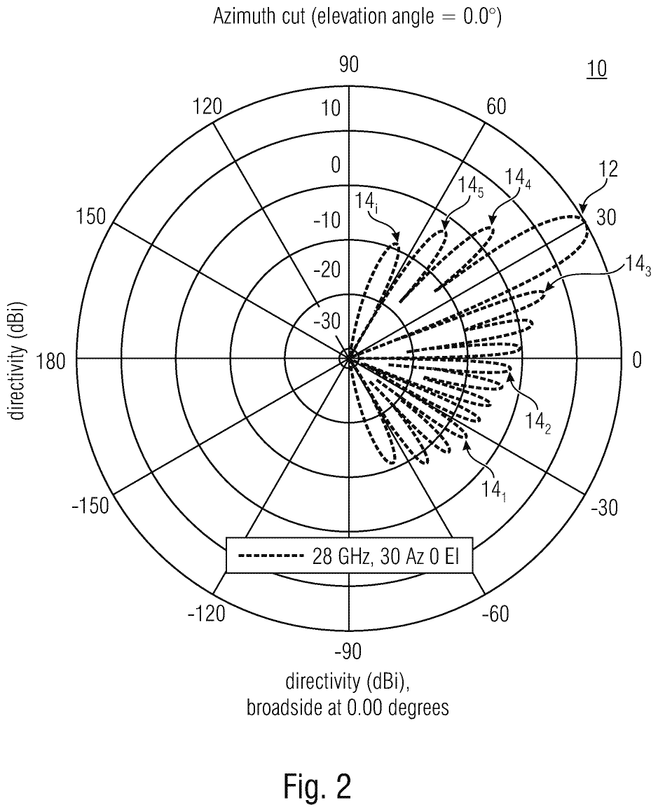

An antenna's directivity is a measure of its ability to concentrate or direct electromagnetic energy in an advantageous or given direction compared to the amount of energy it emits in all other directions. Due to reciprocity, antenna directivity is identical for both transmission and reception. In general, all practical antennas have a directivity greater than unity. Although the directivity of an individual antenna can be influenced through careful design, in order to achieve higher directivity and to control the direction in which the maximum energy is directed, a multitude of antenna elements are often arranged in such a manner that they form an antenna array. Now while the mechanical position of the elements is usually fixed, their electrical excitation can be so arranged to change the characteristics of the radiation pattern of the antenna array. Using such methods, it is possible, amongst other things, to control: the electrical scan angle (the direction in which the main lobe or “beam” is pointed); the overall level of the sidelobes with respect to the main lobe; the level and position of sidelobes; and the depth and position of nulls (which fall in between the main lobe and sidelobe and in between sidelobes). Examples of the two-dimensional antenna radiation produced by an idealized phased array antenna are shown in FIG. 1 and FIG. 2 using rectangular and polar axes respectively.

That is, FIG. 1 shows an example of an idealized antenna radiation pattern 10 plotted using rectangular or perpendicular axes as in a Cartesian coordinate system having an azimuth angle in degrees at the abscissa and a directivity at the ordinate. A main lobe 12 that may also be referred to as (main) beam is illustrated at 30 degrees in azimuth. The antenna radiation pattern may comprise one or more sidelobes 14₁ to 14ᵢ, wherein between two adjacent lobes nulls 16₁ to 16ⱼ may be arranged. A null may be understood as a direction in which less power is transferred (received or transmitted) when compared to adjacent lobes. A reduction of power transfer may be, for example, at least 6 dB, at least 10 dB or the like. A phase distribution may be used to steer the beam or main lobe 12 in the required direction, e.g., using a uniform power distribution. A sidelobe level may be irregular.

FIG. 2 shows a schematic diagram of the antenna radiation pattern 10 being plotted using a polar coordinate system.

Forming an antenna radiation pattern in connection with the embodiments described herein may relate to a static antenna radiation pattern but may also relate to a dynamic, i.e., sweeping antenna radiation pattern. A sweeping beam pattern or antenna radiation pattern may be understood as a constant or varying pattern that is moved in space or in frequency, for example, rotated or laterally shifted. Such a sweeping may allow to adjust a direction of lobes and/or nulls of the antenna radiation pattern.

Directions that are described in connection with present embodiments do not limit the scope of the embodiments to the narrow meaning of a direction, i.e., a single factor. The term direction is to be understood so as to also include a set of dominant angular components which contribute significantly to the received or transmitted signal at the place/location, area/zone or volume of a communication partner. This may be equivalent to a complex 3D receive antenna radiation pattern which collects and weighs different incoming multi-path components to an effective receive antenna input signal. Therefore, direction is not limited to one line but may cover an aggregation of signals from directions collected by their received pattern. A transmit strategy may select a transmit beam pattern which provides good signal power transfer from the transmitter to the targeted received/communication partner.

Devices described herein that may perform beamforming may comprise an antenna arrangement, the antenna arrangement having one or more antenna panels, wherein each antenna panel may comprise one or more antennas. That is, each antenna panel comprises an arrangement of radiating/receiving antennas such that a panel or a subpanel thereof is able to perform a coherent beamforming. That is, for performing a beamforming, a number of antennas grouped to antenna panels, a number of antenna panels and thus a number of antennas in total may be arbitrary.

### Pattern Control

In the context of the preceding discussion, and in order to form the best link between devices (for example a basestation and a piece of user equipment), beam management may be used to ensure that the beams of each device are pointing appropriately. However, known beam management does not consider the effect of interference to other users. In other words, and by way of an example, when a basestation antenna beam is pointed in a given direction—that is, to a device with which it should establish or maintain a connection—the associated sidelobes and nulls of the pattern will follow the beam, arbitrarily. Although the power levels of the sidelobes will normally be lower than the power level of the beam, they could still emit sufficient power towards another device with which the basestation is not connected such that the device experiences interference. In some cases, the power level of the interferer could even exceed the power level of the serving beam.

In other applications of phased array antenna systems pattern nulls are created in such a way that the effects of so-called jammers (sources of strong electromagnetic radiation that are deliberately aimed towards a victim's radar or communication system) can be reduced spatially through adaption of the (victim's) antenna pattern.

Embodiments are thus concerned with the control of the antenna's radiation pattern characteristics in general and not just with the main lobe or beam of the pattern. By controlling, adjusting and adapting the level and the position of the sidelobes and the nulls in transmission, the interference levels to other users can be reduced. Similarly, in reception, pattern control, pattern adjustment and pattern adaption can be used to reduce the interference levels from other users. Embodiments described herein are thus applicable to both transmission and reception.

Antenna arrays may allow to generate transmission radiation patterns and/or reception radiation patterns. For example, in connection with reception or sensing a signal. An array of sensor elements may offer a means of overcoming the directivity limitations associated with a single sensor (antenna), thus offering higher gain and narrower beamwidth than that experienced with a single element. In addition, an array has the ability to control its response based on changing conditions of the signal environment, such as direction of arrival, polarization, power level and frequency [8].

An array consists of or may comprise two or more sensors in which the signals are coherently combined in a way that increases the antenna's performance. Arrays used in embodiments may have the following advantages over a single sensor:
1. Higher gain. The gain is higher, because the array gain is on the order of the number of elements in the array. Higher resolution or narrower main beam follows from the larger aperture size.
2. Electronic beam scanning. Physically or mechanically moving large antennas to steer the main beam is slow. Arrays with phase shifters at each element are able to steer the beam without mechanical motion, because the signals are made to add in phase at the beam steering angle.
3. Low sidelobes. If the desired signal enters the main beam while interfering signals enter the sidelobes, then lowering the sidelobes relative to the main beam improves the signal to interference ratio.
4. Multiple beams. Certain array feeds allow simultaneous multiple main beams.
5. Adaptive nulling. Adaptive arrays automatically move nulls in the directions of signals over the sidelobe region

In addition to the reception advantages described above, an array also offers considerable benefits when used for transmission purposes, too.

Regardless of whether the array is used for transmission or reception purposes, it is normally necessary to provide a means by which the array's antenna radiation pattern can be controlled for the following reasons: to point one or more beams in given directions; to control the direction and relative level of sidelobes; or to control the position and relative depth of nulls.

An example for controlling an antenna radiation pattern may be explained in connection with phased antenna arrays. The examples provided relates to measures to be implemented at or between antennas of an antenna array.

It is noted that objections exist about the term phased array antenna for a scanned beam array antenna, based on the fact that a non-scanned array antenna is still in fact a phased array antenna, as its operation relies on relative phases between the elements. Notwithstanding this argument, the term phased in connection with beam-steered, will be used thereby following the historical development. [8] The term beam former will also be used regardless of whether only a single beam or multiple beams are created.

A phased array is typically comprised of a number of antenna elements arranged in two- or three-dimensional space. The position of the elements with respect to one another is generally fixed—in other words, they do not move in their own array space. This does not however necessarily exclude phased array systems from portable and mobile applications. The elements of an array can be arranged geometrically so as to be linear, planar or conformal in either a regular or an irregular manner. Combinations of the aforementioned categories are also possible.

In the case of a fully digital beam forming system, the antenna elements may be individually connected to their own a transmitter or receiver or transceiver circuit. Alternatively, in an analogue beam forming system, more than one antenna element may be connected to a common radio circuit via either a series- or corporate-feed network. The number of elements per radio is determined by system requirements and design constraints. A so-called hybrid beam forming system combines both digital and analogue implementations.

Almost regardless of the method used to implement the beam former—digital, analogue or hybrid—it is the excitation of its elements that determines certain radiation characteristics of the array. In order to control such properties, for example the direction in which a beam is directed, the phase of individual element excitation has to be configured appropriately. Similarly, sidelobe levels, as discussed below can be controlled through amplitude tapers.

### Realization of Phase Shifting

Having explained the reason for controlling the phase excitation of array antenna elements, this section outlines four example methods that are available for accomplishing a desired phase shift.

### Changing Frequency

Phase shifting by changing frequency or frequency scanning is accomplished by series feeding the array antenna elements whereby the elements are equidistantly positioned along the feed line. By changing the frequency, a changing linear phase taper over the array antenna elements is created, since the input signal has to travel over a physical distance and thus electrical length to reach the i^{th} element of the K-element linear array antenna. If the physical lengths of the feeding lines are chosen such that at the centre frequency, the phased array antenna beam is directed perpendicular to the array or to broad-sight, changing the frequency to values lower than and greater than the centre frequency will direct the beam to, respectively, angles smaller than and angles greater than broad-sight [8]. When a phased array is used for communication purposes however, in which a fixed frequency channel assignment is typical, it is impractical to implement phase shifting by changing the frequency of operation.

### Changing Length

This type of phase shifting may be applied to series-fed arrays, as well as to corporate-fed arrays, [9]. In the pre-digital era, phase shifters based upon changing physical length were realised by electromechanical means. The line stretcher [9] is an example of an early type of phase shifter. The line stretcher is a (coaxial) transmission line section, bent in the form of a ‘U’. The bottom part of this ‘U’ is attached to the two ‘arms’ that form part of the stationary feeding network. The bottom part of the ‘U’ acts as a telescoping section that may be stretched by electromechanical means, thus lengthening and shortening the transmission line section, without changing the position of the ‘arms’ of the ‘U’ [8].

Nowadays, different lengths of transmission line are selected digitally. The switches in every section are used to either switch a standard length of transmission line into the network or to switch a piece of transmission line of a predetermined length that adds to this standard length. These lengths are chosen such that when the cascade of the standard length is taken as reference (having a phase ψ=0°, 16 phases (corresponding to 4 bits), ranging from ψ=0° to ψ=337.5°, in steps of 22.5° (least significant bit) may be selected. Higher resolution can be achieved by using shorter lengths and more bits. PIN diodes—employed in forward and reverse bias—are often used as switching elements [9, 10]. The switched phase shifters may be realised in microstrip technology, using high dielectric constant substrate material, thus minimising physical phase shifter dimensions [8].

Another way of switching physical line lengths is found in the cascaded hybrid-coupled phase shifter. A 3 dB hybrid is a four-port device that divides the power at input port 1, equally over output ports 2 and 3 and passes no power to output port 4. The reflections of the signals that have left ports 2 and 3 return into the hybrid and combine at output port 4, none of the power being returned to input port 1. The diode switches in every segment (bit) of the cascaded hybrid-coupled phase shifter are either returning the signals leaving ports 2 and 3 directly, or after having travelled the extra line length Δl/2 twice. As an example, a four-bit phase shifter Δl2=Δ/32 for the least significant bit, and for the following three bits, respectively, Δl/2=Δ/16, Δl/2=Δ/8 and Δl/2=Δ/4 [8].

### Changing Permittivity (Dielectric Constant)

By adjusting the current that flows through a device containing a gaseous discharge or plasma, its dielectric constant and hence phase shift can be controlled [9]. Another way to adjust the permittivity of a device is through the use of so-called ferro electric materials in which the permittivity is a function of the electric field applied over the material [8]. The permittivity may be adjusted between the antennas of the antenna array. While one approach may be to apply this technique in a device that performs the function of changing the phase of the signal associated with an element of the antenna array, it may, according to another approach, be applied to the structure that forms part of the antenna element and/or the array of antenna elements so as to implement the phase shift by use of the structure, material or arrangement by changing a permittivity. Both approaches may be combined with each other.

### Changing Permeability

Ferrimagnetic materials, or ferrites, are materials for which the permeability changes as function of the change in an applied magnetic field in which the material is positioned. Ferrite-based phase shifters have been in use for a long time, especially in combination with waveguide transmission line technology. In the case of the Reggia-Spencer phase shifter [9]—which consists of a rod of ferrimagnetic material, centrally positioned inside a waveguide, where a solenoid is wound around the waveguide—the phase can be changed continuously, making the phase shifter analogue in nature. On the other hand, the function of the solenoid can be performed by a current wire through a ferrimagnetic rod. By cascading different lengths of ferrimagnetic rods, different (discrete) phase shifts may be realised, thus making such phase shifter digital in nature [8]. The permeability may be adjusted between the antennas of the antenna array. As described in connection with the change of the permeability, while one approach may be to apply a phase shift for changing the phase of the signal associated with an element of the antenna array, according to another approach, the phase shift may be applied to the structure that forms part of the antenna element and/or the array of antenna elements by changing a permeability in the structure and/or between components thereof, e.g., between antenna elements and/or arrays of antenna elements. Both approaches may be combined with each other. Further, changing the permittivity may be combined with changing the permeability in order to obtain at least a part of the phase shift.

As discussed, also amplitude tapers may be used, e.g., to control sidelobes.

The strength or amplitude of the element excitation—also known as the element weight—controls the directivity and sidelobe level of the array factor. Examples of amplitude tapers include binomial, Dolph-Chebyshev, Tseng-Cheng-Chebyshev, Taylor, Taylor-Woodard, Hansen, Bickmore-Spellmire and Bayliss [11]. Low-sidelobe amplitude tapers have high amplitude weights in the centre of the array and the weights generally decrease from the centre to the edges. In general, as the taper efficiency decreases, the half-power beamwidth increases and the sidelobe levels decrease.

### Amplitude Realization

Amplitude excitation adjustment of antenna elements can be realized by controlling the gain of amplifier stages which, depending on the implementation of the system, could include digital gain, intermediate frequency (IF) gain and radio frequency (RF) gain settings for both the transmitter and receiver chains. Where appropriate, active signal amplification can also be implemented in frequency translation stages by, for example, controlling the drive level of local oscillator devices connected to mixer devices. In addition to the aforementioned active devices that introduce signal amplification, passive devices can also be used which, due to their nature, attenuate signals rather than amplify them. Examples of such devices include power dividers or splitters, coupled lines or couplers, transformers, impedance converters, resistive networks and parasitic elements.

Embodiments described herein relate to both, devices that interfere with other devices while communicating and that address the interference they cause by controlling their antenna radiation pattern. For a better understanding such devices may be referred to as interferer or aggressor. Embodiments further relate to devices that detect that they are interfered or disturbed by other devices to which they do possibly not maintain (at least at present) a connection or data exchange. Those devices may be referred to as interfered devices or victim.

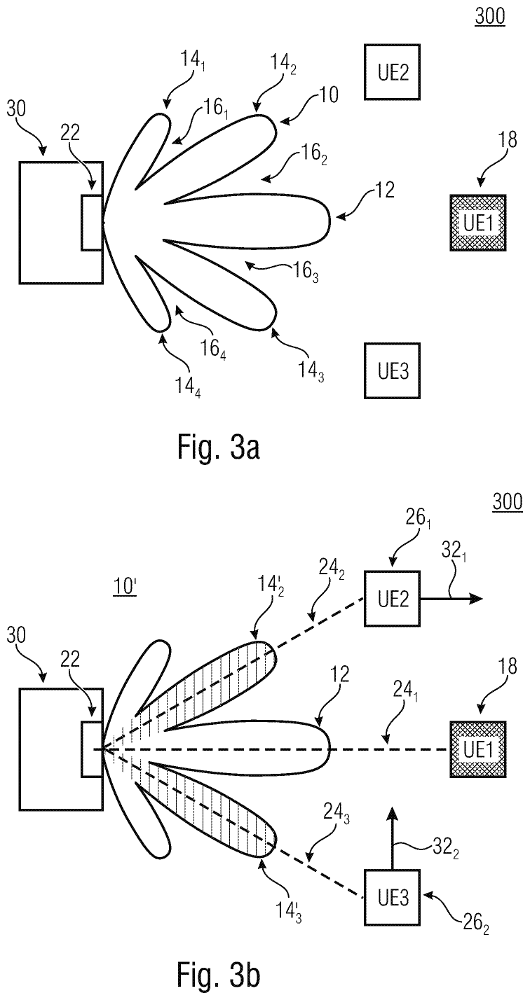

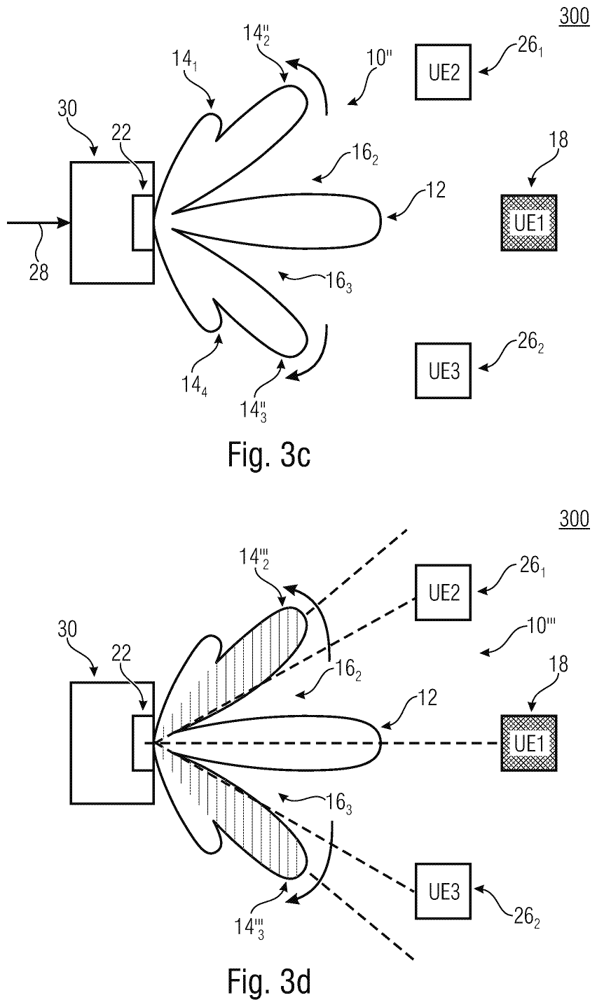

FIG. 3a shows a schematic top view of at least a part of a network 300 in which a device 30 is operating. By way of example, the device 30 may be a basestation such as a gNB or eNB configured for operating a cell of a wireless communication network. Alternatively, the device 30 may also be a UE operating in the cell, for example, when performing a p-2-p communication or when performing communication with a basestation. However, embodiments are not limited hereto but relate to any kind of device being capable of performing beamforming in a way so as to generate an antenna radiation pattern comprising a main lobe and at least one sidelobe. A null 16 may be arranged between two adjacent lobes. The antenna radiation pattern 10 may be a transmission radiation pattern or a reception radiation pattern, i.e., a pattern in which advantageous directions of reception are defined.

By way of non-limiting examples, the device 30 will be described in connection with generating the antenna radiation pattern 10 as a pattern to be used for transmitting a signal, wherein the description provided may be transferred without limitation to a sensitivity in a reception (RX) pattern that also allows for an exchange of energy along one or more advantageous directions (of the lobes) whilst to allow for a reduced amount along other directions (e.g., nulls).

The device 30 may be configured for communicating with a communication partner 18, for example, a UE being identified as UE1. In connection with the example illustrated in FIG. 3a, the device 30 may transmit a signal to the communication partner 18. For doing so, the device 30 may be configured for controlling the main lobe 12 towards a path 24₁ to the communication partner 18. That is, the main lobe 12 may be directed by the device 30 along a Line of Sight (LoS) path or at least one non-LoS (nLoS) path or combinations thereof. This may allow to transfer energy between the location of the device 30 and the location of the communication partner 18. In the described downlink scenario, the energy may be transmitted from the device 30 to the location of the communication partner 18. In case of an uplink scenario, the energy may be transmitted from the location of the device 18 to the location of the device 30, an antenna arrangement 22 thereof respectively.

For a better understanding, according to the described embodiment, the antenna radiation pattern 10 formed by the device 30 is implemented, adapted or generated such that the main lobe 12 points towards the LoS path towards the location of the communication partner 18. Accidently, the antenna radiation pattern 10 may be in a configuration such that one or more sidelobes 14₁ and/or 14₂ are implemented so as to transfer energy to other devices 26₁ and/or 26₂ in the transmit case, the receive case may be operated accordingly. For example, the devices 26₁ and 26₂ are devices within the same cell, a different cell or of a communication network operated by a different operator (which may be referred to as a common network however when regarding the shared resources). Although the sidelobe 14₂ is illustrated so as to point along a LoS path 24₂ towards the device 26₁ and the sidelobe 14₃ is illustrated so as to point along a LoS path 24₃ towards the device 26₂, the sidelobe 14₂ and/or the sidelobe 14₃ may also point along an nLoS path. Alternatively, only one or more than two sidelobes may transfer energy between the location of device 30 and locations of further devices 26, thereby causing interference.

In other words, FIG. 3a shows the antenna pattern of the base station serving UE1. While its main lobe or “beam” is directed towards UE1, its two side lobes inadvertently point towards UE2 and UE3, thus creating interference. Interference reduction may be achieved by adapting the base station antenna pattern as illustrated in FIGS. 3b, 3c and 3d.

FIG. 3b shows a schematic block diagram of the part of the wireless communication network 300 in which a transmission power or sensitivity of the side lobes 14₂ and 14₃ is reduced so as to obtain side lobes 14′₂ and 14′₃ having a reduced power or sensitivity, thereby lowering the amount of energy transferred between the device 30 and the other devices 26₁ and 26₂.

In other words, with reduced power in the side lobes 14₂ and 14₃interference may be reduced.

FIG. 3c shows a schematic block diagram of the part of the network 300 in which the device 30 controls the sidelobe 14₂ and/or 14₃ (optionally a lower number of at least one or a number larger than 2) so as to point along a different direction, to obtain modified sidelobes 14″₂ and/or 14″₃. FIG. 3c thus provides for redirected side lobes 14₁, and 14₂ so as to obtain redirected side lobes 14″₂ and 14″₃ in an antenna radiation pattern 10″. Alternatively or in addition, the device 30 may control a null 16₂ and/or 16₃ in view of its direction which causes also to an indirect control of the sidelobes. For example, creating a null at a varied orientation (in one example along a direction/path along which in a former instance of time a sidelobe was directed) leads to a changed property of the respective sidelobe and/or other lobes. According to an example, device 30 may direct a null 16₂ and/or 16₃ along a path towards device 26₁, 26₂ respectively.

For example, an adaptive array of a victim device may be controlled to adjust the radiation pattern so as to (still) direct the main beam to the direction of the wanted signal and a null to the interferer. For example, an adaptive array of an aggressor device may be controlled to adjust the radiation pattern so as to (still) direct the main beam to the direction of the communication partner and a null to the victim 26. While such a control may also change the sidelobes, such adaption may be very much null related to directing a null towards the interferer. Thus, controlling a sidelobe may result in a null controlled thereby and controlling a null may result in controlling a sidelobe thereby.

In other words, with the side lobes pointed away from UE2 and UE3, interference may be reduced.

FIG. 3d shows a schematic block diagram of a scenario in which the concepts of FIG. 3b and FIG. 3c are combined so as to obtain redirected and power-reduced side-lobes 14′″₂ and 14′″₃ of an antenna radiation pattern 10′″. Both, redirected and power reduced sidelobes allow to transfer a lower amount of energy or even no energy to the locations of the devices 26₁ and 26₂ whilst a combination may be of particular advantage. Meanwhile, the main lobe 12 may remain unchanged or with changes that have only minor, tolerable or negligible effects on the amount of transferred energy. For example, an amount of power transferred with the main lobe 12 and/or a direction thereof may vary within a tolerance range of at most 30%, at most 15% or at most 5%. By controlling the sidelobe 14₁ and/or 14₂, device 30 may address interference at the location of the device 26₁, 26₂ respectively. In particular, the amount of interference at the other devices being not part of the communication between devices 30 and 18 may be reduced or may be kept low so as to allow for a high communication quality and therefore a high communication throughput of the devices 26₁ and/or 26₂.

In other words, FIG. 3d shows a combination of the concept of FIG. 3b and FIG. 3c, i.e., the side lobe level is reduced and is redirected.

FIGS. 3a-3d present examples of how the antenna pattern of the basestation can be adjusted or adapted in order to control the interference towards other devices. These examples include sidelobe power level control, sidelobe spatial direction and combinations of the two and of further measures. Although the figures illustrate a simplified situation in which the power in two sidelobes is reduced equally, or the direction in which the two sidelobes point is changed similarly, practical realizations may be more complex. Error! Reference source not found. 3a-3d for convenience shows a two-dimensional representation situation whereas a real-world system is comprised of three-dimensions.

Examples of the aspects of pattern adjustments, pattern adaption or pattern control that enable the interference reduction to other users comprise but are not limited to:
main lobe and/or side lobe (power) level control;
main lobe and/or side lobe direction in azimuth or elevation or combinations of the two; and
main lobe and/or side lobe polarization.

### Application to Networked Devices

Although FIGS. 3a-3d show the antenna pattern of the basestation only, an antenna pattern may be associated with all of the devices shown—UE1, UE2 and UE3. The situation may be naturally extended to a network comprised of many basestation and user equipment devices. It should thus be noted that the methods of pattern adaption that have been introduced thus far for the basestation can also be applied to user equipment devices comprised of the means to produce a spatially directive antenna radiation pattern. In short, the embodiments disclosed herein are applicable to any device that has some form of beam steering.

Although FIGS. 3a-3d are described in connection with changing a direction of the sidelobe 14₁ and/or 14₂ to address the interference at the location of the device 26₁, 26₂ respectively, the device 30 may alternatively or in addition implement other mechanisms. For example, device 30 may control a direction of the main lobe 12 so as to thereby effect the direction of the sidelobes. When referring again to FIG. 2, a control of the main lobe 12 so as to deviate from the direction of 30 degrees, by, e.g., 1, 2 or 3 degrees may still allow for a high or sufficient transfer of energy to the communication partner 18. At the same time, a direction of the sidelobes may be also shifted, wherein this may allow to avoid illuminating the locations of the devices 26₁ and/or 26₂ (or of other devices) with the sidelobes.

Alternatively or in addition, the device 30 may be configured for controlling a level of power transfer between the device 30 and the device 26₁ and/or 26₂ by way of the sidelobes 14₁, 14₂ respectively and/or by use of the main lobe thereby effecting the level of power transfer at the sidelobes to the location of the device 26₁, 26₂ respectively. A level of power transfer may be controlled, for example, by controlling a transmission power or a sensitivity along the respective lobe.

For example, the device 30 being configured to address the interference by controlling the sidelobe in view of the level of power transfer between the device 30 and the device 26₁ and/or 26, the device may adapt a level of power transmission along one or more paths between the device 30 and the respective device 26₁ or 26₂ in a radio propagation environment. The radio propagation environment may include LoS and nLoS paths, wherein this may relate to single paths or a combination thereof, for example, a set of multi path components that commonly contribute to the interference.

Specific actions may be implemented by device 30 based on a distance between the device 30 and the communication partner 18. For example, the communication partner 18 may be located as a far device. Such a far device may be understood as a device having a distance such that the effective path loss is high resulting in a low Signal to Noise Ratio (SNR) on the desired link. The further device 26₁ or 26₂ (victim) may, in contrast, be located as a near device which may result in a level of received interference at the receive antenna (RX antenna) before the RX beam former which may cause the Automatic Gain Control (AGC) to respond to both signals (desired and interfered) or even to be dominated by a power level from the interferer which may lead to effectively desensitizing the receiver.

Alternatively, the communication partner may be located as a near device and/or the victim may be arranged as a far device.

Alternatively or in addition, the Signal to Interference Ratio (SIR) may be at most a targeted Signal to Interference plus Noise Ratio (SINR) of the desired link (referring to the chosen Modulation Coding Scheme (MCS) level. The device 30 may be configured for reducing the interference level (at the victim) to improve the SINR to improve a link capacity between the device 30 and the communication partner 18.

Alternatively or in addition to the aforementioned mechanisms, the device 30 may be configured for controlling a polarization of the sidelobes 14₁ and/or 14²and/or of the main lobe 12. Alternatively or in addition, the device 30 may be configured for controlling a selection of an antenna port used for forming the antenna radiation pattern 10, of a sub-array of an antenna array used for forming the antenna radiation pattern 10 and/or of at least one antenna panel used for forming the antenna radiation pattern 10. That is, the device 30 may be configured for using another antennas, antenna panels or antenna sub-arrays for generating an antenna radiation pattern that still allows to direct the main lobe to the location of the communication partner 18 whilst providing for a possibly different structure of the sidelobes which may be more suitable to avoid interference at locations of the devices 26₁ and/or 26₂.

Although the embodiments of FIGS. 3a-3d are illustrated so as to generate the antenna radiation pattern 10 and to then adapt the sidelobes whilst maintaining the main lobe, other embodiments may avoid to first generate interference at locations of devices 26₁ and/or 26₂ by generating the antenna radiation pattern 10′, 10″ or 10′″ right from the beginning. For example, the device 30 may have knowledge about a location and/or requirements of the devices 26₁ and/or 26₂ and may consider those requirements already when selecting the antenna radiation pattern to be applied. That is, the device 30 may generate an antenna radiation pattern addressing the interference at non-communicating devices (with respect to the device 30) already at the beginning.

According to an embodiment, the device is configured for selecting the antenna radiation pattern 10′ from a plurality of possible antenna radiation patterns. The possible antenna radiation patterns may be understood as a set of formable or creatable antenna radiation patterns that may be taken from a prepared or preselected set of antenna radiation patterns which may be obtained, for example, from a codebook. The device may be configured for generating the selected antenna radiation pattern and to adapt the generated radiation pattern to reduce the interference between the device 30 and the device 26₁ or 26₂ when compared to the selected antenna radiation pattern. Such a scenario is illustrated in FIGS. 3a-3d. For example, the device may select the most usable or appropriate antenna radiation pattern to communication with the communication partner 18. Alternatively, the device 30 may select the antenna radiation pattern from a plurality of possible antenna radiation patterns so as to lead to an interference below a predefined interference threshold between the device and the further device. The predefined interference threshold may be an absolute value of the interference level, e.g., a value relating to a specific power or the like, or may be a relative value, e.g., a minimum interference level amongst the usable or suitable radiation patterns to communicate with the communication partner 18. The minimum value may be encompassed with a tolerance range and/or weighting values so as to optimize both, the power transfer to the intended communication partner 18 and the power transfer (reduction thereof) to the victims 26₁ and/or 26₂. That is, the device 30 may select the antenna radiation pattern from the plurality of possible antenna radiation patterns so as to lead to a minimum interference between the device 30 and the device 26₁ and/or 26₂ whilst providing for an energy transmission above a predefined transmission threshold between the device 30 and the communication partner 18 or a maximum energy transmission between the device 30 and the communication partner 18.

When referring again to FIGS. 3a-3d, addressing the interference at the victims 26₁ and/or 26₂ may be implemented by controlling at last one of a direction of a load, a level of power transfer, a polarization and a selection of an antenna port. When controlling a direction of a sidelobe, a control parameter to be applied by the device 30 may be the implemented direction of the sidelobe and/or a direction of a null of the antenna radiation pattern. That is, by directing, for example, a null to the location of the victim, thereby implicitly sidelobes are directed or located to other locations. Alternatively or in addition, a direction of the sidelobe may be controlled actively, e.g., far away enough from the location of the device 26₁, 26₂ respectively. Far enough away may be understood such that the interference caused by the device 30 at the location of the device 26₁ or 26₂ is below an interference threshold level.

For addressing the interference, the device 30 may alternatively or in addition be configured for performing a beam sweeping procedure to address the interference at the location of the device 26₁ and/or 26₂. During a beam sweeping procedure, the antenna radiation pattern 10 may at least in parts be moved in space. A beam sweep may be understood as moving the radiation pattern from one side to another or forth and back thereby illuminating different locations with the beams in a time variant manner.

For addressing the interference, alternatively or in addition, the device may be configured for implementing a pattern to the antenna radiation pattern in view of a blanking, puncturing or power boosting pattern. Thereby, punctured, blanked or power boosted resources of the antenna radiation pattern may be made specifically observable at the location of the device 26₁ and/or 26₂ via a multipath propagation environment at least in parts. Interference may be addressed thereby as the punctured, blanked or power boosted resources may form a specific pattern (e.g., of resources having no, low or high power) which may be associated with the identity of the device 30.

This association may be known throughout the network and/or at the device 26₁ or 26₂ but may also be unknown. When being unknown, the pattern may nevertheless be associated with the identity of the device 30 as at least the device 30 knows the pattern it implements. The implemented pattern may allow to assess or identify the interfering source/interference source/interference effect which then allows to reduce interference levels. Whilst a known or predefined beam pattern allows to correlate and detect/identify the interference source or the interference pattern, an unknown pattern may be identified and provided to a network for a source identification. Alternatively or in addition, the unknown pattern may be compared to a data base for a source identification or may be used for successive further signal processing after identification, e.g., successive interference source detection/identification.

The interference addressed by device 30 may comprise a co-channel interference and/or an adjacent channel interference, i.e., interference caused in the same channel/frequency spectrum (of a same or different operator/provider), in adjacent channels (of a same or different operator/provider) respectively. For determining an adjacent channel interference, different mechanisms such as ACLR (Adjacent Channel Leakage Ratio) measurements may be used to determine such interference. It is noted that adjacent channel interference is not only related to channels that are direct neighbours but also relate to other channels that are different from the interference suffering channel e.g., sidelinks or in other networks. Such interference can be caused by transmitter sources which for instance form mixing products like differences, sums or harmonics with a distant (e.g., in frequency) channel that affects the suffering channel. For example, a 1.8 GHz channel may affect a 3.6 GHz channel. Even in such a scenario the aggressor device may operate in a different spectrum or in a different band (of a same or different operator/provider) whilst still affecting the victim, e.g., in view of the SINR obtained at the victim. Multiple ways of recognizing such interference are presented herein, e.g., providing information that allow to identify the aggressor. That is, embodiments are not limited to specific types of interference but relate to actively avoid interference at devices not communicating with the device 30.

When referring again to FIGS. 3a-3d, the device 30 may be configured for obtaining knowledge about a location of the device 26₁ and/or 26₂. Alternatively or in addition, the device 30 may obtain knowledge about at least one direction of a relevant multi path component (MPC) between the device 30 and the device 26₁ or 26₂. Based on at least one of the location and the direction of the MPC the device may control the sidelobe to comprise a low amount of power transfer between the device 30 and the location or along the at least one direction so as to address the interference. That is, the locations as well as the direction where interference has to be avoided may both allow to reduce the interference at the location of the victim.

As shown in FIG. 3c, the device 30 may be configured for obtaining knowledge about a request 28 to reduce interference at the location of the device 26₁ and/or 26₂. The request 28 may be based on a report 32₁ being reported by device 26₁ and/or by a report 32₂ being reported by device 26₂ responsive to being interfered. That is, when receiving relevant signal power from the device 30 or signal power above a threshold, the respective device may report this situation to its network or to a specific node of the network. For example, the devices 30 and 26₁ and/or 26₂ being operated in a same network or same network cell, the devices may exchange the report 32 and/or request 28 directly. When being operated by different providers, the device 26₁ and/or 26₂ may transmit their reports 32₁ or 32₂ to a node of their networks as to allow for an exchange of information between the different networks such that the device 30 receives the request 28 from its own network. That is, the device 30 may be configured for receiving directly (e.g., intra-network) or indirectly (e.g., inter-network) a reporting 28 about a measure of interference at the devices 26₁ and/or 26₂. The report 32₁ and/or 32₂ may be based on a reception of wireless energy transmitted by the device 30. As will be explained in more detail later, the report 32₂ and/or 32₂ may also be based on a prediction. For example, the report may be predictive based on a location or movement of the device 30 relative to the device 26₁, 26₂ respectively. This may include a movement of the device 30 and/or of the device 26₁, 26₂ respectively.

As described, the device 30 may be configured for controlling a single sidelobe of the antenna radiation pattern 10 or may be configured for controlling a plurality of sidelobes of the antenna radiation pattern so as to address interference at a plurality of locations. The device 30 may be configured for addressing the interference at the location of the device 26₁ and at the location of the device 26₂. The device 30 may be configured for controlling at least the sidelobe 14₁ and 14₂ of the antenna radiation pattern 10. This controlling may be based commonly or may be based on a sidelobe-by-sidelobe assessment, i.e., the sidelobes may be controlled individually.

In a direct or indirect way, the device 30 may receive a signal from the device 26₁ or 26₂ indicating an exchange of energy or an observation of received power between the device 30 and its victim.

The device 30 may perform, responsive to having acquired information about a request to reduce interference at the location of the device 26₁ and/or 26₂ one or more of the following steps. Acquiring information about a request to reduce interference may comprise a reception of the report 32₁ or 32₂ and/or of the request 28. The device may perform, for example, a renegotiation between devices forming a link in which the device is one part of that link, advantageously by adapting the antenna pattern for the transmitting devices and/or that of the receiving device. That is, the device 30 and/or the communication partner 18 may adapt their antenna patterns. Alternatively or in addition, the device 30 may perform a pattern restriction of the antenna radiation characteristic in view of a direction/coverage/illumination. For example, when the device 30 is a drone flying over a base transceiver station (BTS) or when the device is a vehicle in a tunnel or when the device is a possibly low-earth (or other) orbiting satellite that communicates with a terrestrial device as communication partner or vice versa, temporarily a direction or coverage or illumination area may be adapted. Alternatively or in addition, a goal-based or target-based action may be performed, e.g., to reduce a power effecting the device 26₁ and/or 26₂. This may include a reschedule and/or coordinate of beams of the selected transmit antenna pattern. Alternatively or in addition, the device may perform a command-based action, e.g., to use a specific beam X when a specific condition Y is present. Alternatively or in addition, the command may indicate to not use beam P when condition Q happens. Alternatively or in addition, the device may be adapted to use selective codebook entries (e.g., a Type I single-panel codebook; a Type I multi-panel codebook; a Type II single-panel panel codebook; and/or a Type II multi-panel codebook or a different codebook) or beam indexes.

In general, addressing interference may be based by implementing devices that perform respective actions, e.g., by controlling an antenna array so as to implement a phase shifting and/or an amplitude control, e.g., as described above. These means may require practical implementation which may lead the performance of the components or devices used to be affected to a greater or lesser extent by operational and environmental conditions. With respect to operational conditions, the typical performance of a device may be altered due to, for example: the frequency of operation; the bandwidth of the signal; the power of the signal; the modulation of the signal; the number of signals; the number of streams contained within a signal; the presence or absence of other signals; the required scan angle; the polarization; the coupling or mutual-coupling of energy between antenna elements, sub-arrays and antenna panels; ageing effects; and element and component failure. Whereas with respect to environmental conditions, the typical performance of a device can be changed by, for example: temperature; humidity; altitude; solar radiation; electric fields; magnetic fields and/or vibration.

As explained previously, in order to form the phase array antenna radiation pattern appropriately—according to operational criteria—the signal associated with each antenna element of the phased arrays may be suitably adjusted, in phase and/or amplitude, often in both phase and amplitude. According to embodiments, at least one of two examples of methods that may be used to implement this effect; codebooks and adaptive arrays.

### Codebooks

According to an embodiment, a device to address interference may us a codebook for forming the antenna radiation pattern. Thereby, the sidelobes and/or nulls may also be controlled directly (e.g., by selecting a suitable codebook-entry) or iteratively (e.g., by adapting the antenna radiation pattern by iteratively selecting codebook entries). A so-called codebook may provide a convenient method of organizing and retrieving the beamforming vectors associated with a phased array antenna. For example, each column of a codebook matrix may specify the phase shift of each antenna element, and a practical beam can be generated with the phases specified in each column of the codebook [11].

According to an example, the device may use a codebook that comprises or is one or more of a so-called
Type I single-panel codebook;
Type I multi-panel codebook;
Type II single-panel codebook; and
Type II multi-panel codebook
   which does not exclude to alternatively or additionally use other codebooks.

In the context of systems that enable multiple-input multiple-output (MIMO) operation, for example 5G and beyond 5G systems, the MIMO precoding matrices are also known as codebooks. The design of such codebooks is based on a trade-off between performance and complexity. The following are some desirable properties of the codebooks [13]:
1. Low-complexity codebooks can be designed by choosing the elements of each constituent matrix or vector from a small binary set, for example, a four alphabet (±1, ±j) set, which eliminates the need for matrix or vector multiplication. In addition, the nested property of codebooks can further reduce the complexity of CQI calculation when performing rank adaptation [13].
2. A basestation may perform rank overriding which results in significant CQI mismatch, if the codebook structure cannot adapt to it. A nested property with respect to rank overriding can be exploited to mitigate the mismatch effects [13].
3. Power amplifier balance is taken into consideration when designing codebooks with constant modulus property, which may eliminate unnecessary increases in peak-to-average power ratio (PAPR) [13].
4. Good performance for a wide range of propagation scenarios, for example, uncorrelated, correlated, and dual-polarized channels, is expected from the codebook design algorithms. A DFT-based codebook is optimal for linear arrays with small antenna spacing since the vectors match the structure of the transmit array response. In addition, an optimal selection of the matrices and the entries comprising the codebook (e.g. rotated block diagonal structure), offer significant gains in dual-polarized scenarios [13].
5. Low feedback and signaling overhead are desirable from an operation and performance perspective [13].
6. Low memory requirement is another design consideration for the MIMO codebooks [13].

### Adaptive Arrays

An adaptive array may comprise an algorithm which is possibly computer-based and that controls the signal levels at the elements until a measure of the quality of the array performance improves. It may adjust its pattern formed, i.e., the antenna radiation pattern, to form nulls, to modify gain, to lower sidelobes, or to do whatever it takes to improve its performance. An adaptive array offers enhanced reliability compared with that of a conventional array. When a single sensor element/antenna element in a conventional array fails, the sidelobe structure of the array pattern degrades. With an adaptive array, however, the remaining operational sensors in the array automatically adjust so as to restore the pattern. For this reason, adaptive arrays are more reliable than conventional arrays, since they fail gracefully. The reception pattern of an array when installed on a structure such as a tower or a vehicle, or when held in the hand, placed next to the head, or worn on the body, is often quite different from the array pattern measured in isolation (in an anechoic chamber) as a result of signal scattering that occurs from vehicle structures in the vicinity of the antenna or from interaction with the user. An adaptive array may yield successful operation even when antenna patterns are severely distorted by near-field effects. The adaptive capability overcomes a lot of or even any distortions that occur in the near field and merely responds to the signal environment that results from any such distortion. Likewise, in the far field the adaptive antenna is oblivious to the absence of any distortion [11].

An adaptive array may improve the SNR by preserving the main beam that points at the desired signal at the same time that it places nulls in the pattern to suppress interference signals. Very strong interference suppression may be possible by forming pattern nulls over a narrow bandwidth. This exceptional interference suppression capability is a principal advantage of adaptive arrays compared to waveform processing techniques, which generally require a large spectrum-spreading factor to obtain comparable levels of interference suppression. Sensor arrays possessing this key automatic response capability are sometimes referred to as “smart” arrays, since they respond to far more of the signal information available at the sensor outputs than do more conventional array systems [11].

### Pattern Control Using Codebooks and Adaptive Antennas

While codebooks and adaptive algorithms each offer their own particular advantages and disadvantages, it is not immediately obvious how the merits of the two can be combined simply and effectively in a practical system. This is further exacerbated when the practical realization of a phased array is considered together with the operational and environmental impairments that were introduced above.

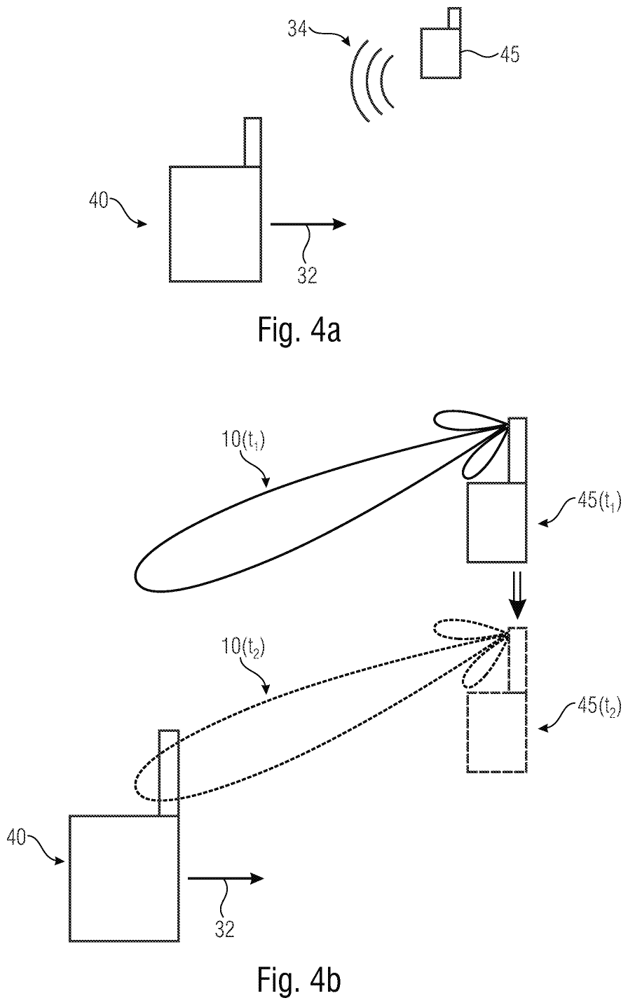

FIG. 4a shows a schematic block diagram of a device 40 according to an embodiment. The device 40 is explained, in the following in view of a victim device, i.e., a device which is interfered by an interfering signal 34, e.g., one of the sidelobes 14 of a device 45 which may be device 30 in an embodiment. The device 40 is configured for operating in a wireless communication network. The device 40 is configured for communicating with a communication partner, e.g., in the wireless communication network. Optionally the device 40 may be configured for forming an antenna radiation pattern, i.e., is able to perform beamforming, whilst in other embodiments device 40 does not perform beamforming.

The device 40 is configured for determining a measure of interference associated with a device not communicating with the device 40. For example, the device 40 may be the device 26₁ of the wireless communication network 300 and does not intend to communicate with the device 30 which may be a source of the interfering signal 34. The device 40 may be configured for determining a measure of interference associated with the device 40 based on a reception and evaluation of the interfering signal 34 or by an expectation about receiving the signal in the future. The device 40 may be configured for reporting to the interfering device 45 or a member of the communication network in which the interfering device 45 operates about the reception of power or the happened/expected interference from the interfered device 45, the aggressor.

FIG. 4b shows a schematic block diagram of an interaction between the device 40 and the interferer 45. Although, at a time T₁ the device 45 may not interfere with the device 40 or may interfere at a low, possibly tolerable level, the device 40 may have knowledge about a movement of the device 45 and/or of at least parts of the antenna radiation pattern 10 generated by device 45. Based thereon, the device 40 may expect the device 45 to interfere the communication of the device 40 at a later time T₂. Based on this expectation or prediction, the device 40 may provide for the report 32 as a precautionary measure, thereby indicating that it expects to be interfered at time T₂. Such an expectation may be based on a movement of the device 45 and/or based on a movement of a communication partner of the device 45 which may cause the device 45 to adapt its antenna radiation pattern. For example, based on a relative movement between the device 45 and its communication partner, the device 40 may temporarily be arranged along a direction of one or more multipath components of the interfering communication. Alternatively or in addition, the device 40 may move and the prediction may indicate that the device 40 expects itself to travel along or through one or more sidelobes of a communication between the device 45 and its communication partner. That is, the device 40 may be configured for determining the measure of interference based on a reception of wireless energy transmitted by the further device 45 and/or predictive based on a location or movement of at least one of the device 40, the interfering device 45 and the communication partner of the interfering device 45.

The device 40 may be configured for determining at least a part of the antenna radiation characteristic 10 generated by the device 45 and for reporting about the measure of interference so as to report about the at least part of the antenna radiation characteristic 10, e.g., by means of the report 32. Thereby, it is possible to obtain knowledge within the network about the antenna radiation characteristic 10 at least in view of those components that may be measured at the receiving device and/or the interfered devices. In other words, it is possible that the generated antenna radiation characteristic is observed at the victim's position using a particular observation filter, e.g., a receive beam former or other means to receive an effective/resulting interference power superimposed with the intended signal (of the victim) from its own communication partner. If the level thereof is larger than the SNR with its own communication partner, then this may be considered as harmful interference. As an example, in uplink, a BTS may track a UE in its cell and another UE from another cell (aggressor) may interfere on this co-channel resource. At a current chosen RX beam pattern, the interfering UE may not be an issue, but when tracking its own UE, an RX sidelobe point to the interfering UE and degrees of freedom for informing might not allow for change/adaptation of RX pattern, e.g., placing a null towards the interfering aggressor. In such situations, the interfering UE may be requested to not transmit towards the victim BTS. This may allow the aggressor to adapt its radiation pattern as described in connection with FIGS. 3a-d.

The device 40 may be configured for reporting to the device 45 (e.g., device 30) about their reception (happened or expected) via a feedback channel or a control channel of the same network of a different network. The reporting about the past or expected reception may be based on at least one of
a Cell Identification (ID) of a cell of a wireless network;
a beam characteristic/identification;
a localization or geolocation;
a power class;
a sounding reference symbol (SRS);
a synchronization signal block (SSB);
a channel state information reference signal (CSI RS);
a bandwidth part (BWP);
a blanking/puncturing/boosting pattern; and
a reference signal (RS) and/or data transmitted from interfering source to be used as pseudo RS.

The device 40 may be configured for qualifying or quantifying or classifying or categorizing the reception of wireless energy, e.g., when receiving or expecting the interfering signal 34 based on at least one of:
a signal-to-interference-plus-noise ratio (SINR) degradation;
a signal-to-interference (SIR) ratio;
an interference level;
a hybrid automatic repeat request (HARQ) acknowledgement (ACK) or negative ACK (NACK);
an SINR/SIR level analysis, e.g., per (HARQ) retransmission packet or per receive beam pattern;
an SIR/SINR margin with respect to a targeted SINR; and
an SINR margin with adaptive beamforming considering reception (RX) nulling.

For example and in connection with the RX nulling, when the BTS is performing adaptive beam forming for UE tracking, i.e., to follow a relative movement between the UE and the device/BTS, then nulls towards the interferer can be easily placed as long as directions towards to the target UE and the interferer are distinguishably distributed/separated in the angular domain. If an angle between them falls below a threshold (e.g., both directions become indistinguishable or inseparable) the SIR may be reduced which effects the link, therefore the interferer may reduce its interference towards the direction/location of the BTS (victim). This may improve to ask/request for adaptive interference suppression at the aggressor before the victim link suffers. This may be referred to as predictive interference avoidance.

The device 40 may be configured for quantifying and/or qualifying the device 45 as a source of interference based on at least one of
a parameterization of potential aggressor characteristics
a time slot, a resource grid, an assigned channel and/or a BWP;
SRS, SSB, CSI RS;
a direction from which the signal 34 is received or expected;
a polarization of the signal 34;
an operating frequency and/or channel assignment;
a direction of transmission in uplink or downlink; and
an observed blanking/puncturing/power boosting pattern.

That is, one or more of these characteristics may be used by the device 40 so as to identify the device 45 which may allow to precisely report about the ongoing or expected interference so as to allow the device 45 to avoid or reduce this interference.

A parametrization of the potential aggressor may be performed, at least in parts by evaluating and/or associating with the aggressor-device one or more of the following.
Operating frequency/channel
Operating bandwidth
Carrier aggregation details
Transmission power
Transmission polarization
Transmission direction
Type of transmission (constant, scheduled, random, responsive to others)
Number of beams used
Properties of the beam(s) (beamwidth)
Multiplex characteristics—TDD/FDD or full-duplex
Modulation
Spatially static (fixed location) or spatially agile (changing position, i.e., mobile)
Location (fixed, updated, predicted/estimated)

It is to be noted, that additionally information with regard to another device such as location may be used. E.g., from a location one may derive a direction.

The device 40 may be configured for reporting the reception, i.e., to include information into the report 32, based on at least one of:
a full set, a sub-set, a compressed/reduced set of parameters; the reception report parameters may, for example, include one or more of the following:
   Received power (also per beam, per component carrier)
   Received channel
   Received direction
   Received signal-to-noise ratio (SNR)
   Received signal-to-interference ratio (SIR)
   Received signal-to-interference-plus-noise ratio (SINR)
   Determined channel quality information (CQI)
   Observed channel
an incremental, differential, event-based and/or ordered list; as a basis for comparison, such generation-techniques may be considered in view of techniques used for data storage backup:
   an incremental report may include all new parameters and all parameters that have changed since then first report
   a differential report may include all parameter changes that differ when compared to the first repot
   upon a certain event (e.g., change of channel/beam/power) an event-based report may be triggered
   when the parameters are arranged in a specified sequence or are otherwise “ordered”—with or without a label that identifies the parameter being reported—the report is said to be an ordered list

The device 40 may provide its report according to one or more of:
trigger/threshold based or event based, e.g., in case of interference or curing, being expected and/or arriving at a certain threshold;
upon request;
timed;
synchronized;
queued; and
trailing/lagging/windowing (e.g., last×minutes, which provide a hint about a masking/interrupts); For example, the use of terms like trailing, lagging and/or windowing may be used to describe the nature of the report and to illustrate that the report is not necessarily always immediately available. In this case the report may be provided some time after the occurrence of the events whose results are reported—hence the terms like trailing and/or lagging are used. Windowing explains that observations may be made during a certain time interval or window;
calibrated/authorized/verified/certified/type approved; since other (network) devices (e.g., victims) may be given the opportunity to report the performance of other (network) devices (e.g., aggressor) such that the other devices may have to change their operation, it may be of advantage to assess the quality or value or authority of such reports. To this end, reporting devices may, in order of increasing credibility, comprise:
   the device may be calibrated (e.g., in the factory)
   the device may be authorized (e.g., by the network)
   the device may be verified (e.g., by some other entity, such as inside or outside of the network)
   the device may be certified (e.g., by a test house or other trusted entities)
   the device may be type approved (e.g., by a fully traceable measurement authority)

The device 40 may be configured for reporting about the reception directly to the device 45, e.g., when being operated in a network or part thereof by a same operator or integral network infrastructure. Alternatively, the device may report to a different entity such as to a node of its own wireless communication network, e.g., a coordinating node, a base station or a different device to piggyback its information. This information may then be forwarded to the device 45 in an intra-network manner or an inter-network manner. Thus, the device 45 may be a member of the wireless communication network in which the device 40 operates but may also be not a member of the wireless communication network. In both cases, the reporting to the device 45 may be implemented indirectly by report to an entity of the wireless network to forward the report 32 and/or to an entity of a further network in which the device 45 is a member. The report may allow to trigger counter measures by the device 45, e.g., as described in connection with the device 30. That is, a communication may include a communication path victim→network of the victim→network of the aggressor→aggressor.

Example wireless communication networks to communicate with each other, e.g., the device 40 and the device 45 being operated in different wireless communication networks may include one of:
geographically co-located networks of a same or different Mobile Network Operator (MNO) including fixed wireless access (FWA) networks, private networks, integrated access and backhaul (IAB) networks, e.g., in half-duplex or full-duplex;
non-terrestrial network to terrestrial network;
maritime network to terrestrial network;
maritime network to non-terrestrial network; and
any possible combination thereof.

### Pattern Assessment and Verification

An aspect of the embodiments described herein is to assess the antenna pattern characteristics of devices deployed in the field using other deployed devices. For example, user equipment devices can be arranged in such a manner that they provide reports of the signals they receive on the beams created for reception purposes even if those beams are not used directly for communication. By extension of this example, a UE could be appropriately configured to observe the characteristics of other networked devices. Similarly, basestations could also be suitably arranged so as to observe or assess the antenna-related performance of other network devices. An important aspect of this part of the embodiments described herein is that any device in the network could be organized to provide such functionality, examples of which can be taken from the list
Observation methods
Observation parameters
Method of observation
Interval of observation
Prioritization of observation

### Feedback Path or Control Channel

In order for pattern assessment and verification information to be transferred from one device to another, embodiments provide for a feedback channel or control channel. This channel, which may operate independently and even in isolation to the communication channel between devices, provides the means for inter-device reporting. This allows the necessary information to be conveyed between devices even when those devices are not required to form a communication link. Indeed, it is the notion of (communication) connected devices causing interference to other devices (with which they are not connected) that led to the suggested interference reduction.
Type of information
Structure of the information
Method of connection
Feedback procedure

Networks according to embodiments may comprise at least one interfering device or aggressor, e.g., a device 30. The wireless communication network further comprises at least one interfered device, e.g., a victim, e.g., device 40. For example, the device 26₁ and/or 26₂ being implemented as device 40 may lead to the wires communication network 300 being such a network.

The interfering device may be configured for addressing the interference in a link between at least one of:
a base station and a user equipment;
a base station and a backhaul entity;
a base station and a relay entity;
a first relay entity and a second relay entity;
a relay entity and a further infrastructure;
a first base station and a second base station;
a first UE and a second UE;
a UE and a further infrastructure and
a UE and a relay entity.

According to an embodiment, the interfering device may be configured for addressing the interference affecting a link operated between a device communicating with the interfered device and the interfered device communicating with a communication partner. That is, the aggressor may address the interference it causes to the communication maintained by the victim. That is, the communication to a transmitter and/or receiver/transceiver talking to the victim may be considered. The victim may receive a message from its communication partner. The aggressor may address the interference by at least one of:
applying interference mitigation/avoidance measure, e.g., using an appropriate antenna radiation pattern that allows for a low amount of interference;
always or in a coordinated synchronized manner or at least when the victim is scheduled to receive information from its communication partner, the aggressor may adapt its own communication; and/or
allowing the victim to successfully listen to control channels of the communication partner, e.g., provisions of grants for future messages to and/or from the victim or aggressor.

As described, an aggressor device in accordance with embodiments, e.g., device 30 may be configured for transmitting a signal with the antenna radiation pattern and/or may receive a signal with the antenna radiation pattern. That is, the embodiments described herein relate to both, a transmit case and a reception case, wherein both cases may be combined with each other.

Although embodiments relate to various scenarios, there may be two interference scenarios to be considered in connection with a co-channel interference and/or an adjacent channel interference. Embodiments consider a near/far affect meaning that the own communication partner is far away and the effective pathloss is high resulting in a low SNR on the desired link. At the same time, the interferer is near resulting in a level of received in a level of received interference at the RX antenna (before the RC beam former) causing the AGC to respond to both signals (desired and interferer) or to be dominated by a power level from the interferer, thereby effectively de-sensing the receiver. Although referring to a near and a far distance, such a scenario may be independent from a physical distance but may relate to the transmission power used. A solution for this scenario is to reduce the transmitted power/energy from the interferer towards the receiver/victim antenna, e.g., by requesting or instructing the aggressor to do so.

Another scenario is that the SIR is equal or lower than the targeted SINR of the desired link (at the chosen MCS level). A solution is a reduction of the interference level which allows an improvement of the SINR such that the link capacity may be improved.

If such scenarios are aggregated, i.e., interferences coming from multiple sources, and a value below the targeted SINR level of the desired link is obtained after the receive beamforming and/or signal processing methods, interference control may be omitted.

A further point pertaining to the embodiments disclosed herein—interference reduction through antenna pattern adaption—is applicable to numerous network device links including the following:
Basestation to user equipment
Basestation to backhaul
Basestation to basestation (relaying/repeating—both regenerative and non-regenerative)
Basestation to other infrastructure
User equipment to other infrastructure
User equipment to user equipment (cross-link)

In many applications, the level of the sidelobes and the direction in which they point could be changed on a sidelobe-by-sidelobe basis. That is, providing that there are means to allow it, each sidelobe may be controlled separately or individually. Devices in accordance with embodiments may be configured for a respective sidelobe-by-sidelobe control.

It should be noted however, that any adaption of the antenna pattern will not only affect the sidelobes, but the main lobe too. This means that pattern adaption is likely to reduce the gain of the antenna and hence affect the range of the communication link. An engineering trade-off between the aforementioned antenna and system characteristics is thus necessary.

Embodiments relate to a reduction of interference at devices which are not part of the communication causing the interference. This may, under some circumstances, also relate to a sidelink interference. Embodiments are related to reporting about interference and to control the antenna radiation pattern.

### EXAMPLES OF CONTROLLABLE CHARACTERISTICS

Applicable to both transmission and reception
Examples of interference include co-channel and adjacent channel
Antenna pattern control->level and direction of: beams; sidelobes; and nulls.
Selection of: polarizations; antenna ports; sub-arrays; and panels

CPE1 (the interference observing network device (IOND)) or victim is observing over a specified time window (define size)

Link affecting interference (e.g. DL from its BTS or side link from another UE relay)
Interference examples
   Multi-access interference (2 UEs to same BS)
   DL inter-BS interference (2 BSs to one UE)
   Inter-UE interference/Inter-BTS interference (caused by different TDD timing between networks)
   Inter-relay interference in multi-hop networks

### Interference Observing Network Device

A device (victim) in the network which by receiving radio signals from surrounding network devices can determine link quality impact on its own existing/repeated/to be established active radio communication link between a transmitter and its receiver.

IOND is monitoring/capturing interference source parameters (e.g., direction, timing, frequency, polarization, physical PRBS, BWPs) associated with receive beams

An IOND assesses the interference impact of other network devices to be (potentially) used for interference management.

### Observation Assisting Information and Procedures

Provided by the network or other network elements describing or allowing identification of interference sources
   Cell IDs, beam characteristics/identification, localization, geolocation, power class, SRS, SSB, CSI RS, BWP, blanking/puncturing pattern(s)
Activation of beam sweeping or of specific beams or blanking/puncturing patterns

### Quantifying and Qualifying Interference Impact (on Victim From Aggressor)

SINR degradation, SIR level, interference level, HARQ ACK/NACK
SINR/SIR level analysis per
   (HARQ) retransmission packet
   Receive beam/pattern

### Quantifying and Qualifying Interference Source

Parameterization of potential aggressor characteristics
   Time slot, resource grid, assigned channel, BWP
   SRS, SSB, CSI RS
   Direction (polarization?)

### Examples of Parameters to be Reported by the Victim

Method of reporting
   Full set, sub-set, compressed/reduced set, incremental, differential, event-based, ordered list, trigger/threshold based, requested, timed, synchronized, queued, trailing/lagging/windowing (last×minutes)—hint about masking/interrupts
   Calibrated/authorized/verified/certified/“type approved”

### Interference Mitigation and Negotiation Procedures (Between Devices)

Intra-network operation
   From victim to aggressor
   From network to aggressor
   From victim via network to aggressor
Inter-network operation
   Examples include:
      Geographically co-located MNOs (including FWA networks), private networks, IAB networks (full duplex)
      Non-terrestrial network to terrestrial network
   From victim via network to another network that hosts the aggressor

### Interference Mitigation Actions (at aggressor)

Purpose—to stabilize the link controlling the aggressor
Renegotiation between devices forming a link in which the aggressor is one part of that link specifically by adapting the antenna pattern of the transmitting devices and perhaps that of the receiving device.
Pattern restriction in direction/coverage/illumination (drones over BTSs, vehicles in tunnels)
Goal or target based actions (e.g. reduce power affecting the victim, reschedule, coordinate beams of selected transmit antenna pattern)
Command based actions (e.g. use beam X when condition Y, or do not use beam P when condition Q)
Selective code book entries or beam indices

Embodiments are described herein in view of specific actions that are undertaken by an interfered device and/or an interfering device. Such actions may be autonomously determined. Some embodiments relate to feedback channel or other communication means which offer the opportunity to inform other devices about specific actions being planned, executed or instructed, e.g., by a coordinating node that informs an interferer about information collected from multiple interfered devices. It furthermore allows to evaluate and learn from such data. Embodiments therefore relate to the field of machine-learning and artificial intelligence.

For example, electronic design automation (EDA) tools are used in the design flow of, for example, electronic components, integrated circuits, printed circuit boards, connectors, cables, modules and systems. EDA tools provide the means to design, simulate, analyse and verify designs with a high degree of accuracy that often leads directly to manufacturing preparation. Simulations can be limited to one physical field—for example electricity, electromagnetics, thermo-mechanics—or in the case of so-called Multiphysics, a simultaneous combination of multiple physical fields. This allows complex simulation systems and environments to be developed in which a phased array antenna system, comprised of electromagnetic field solvers and circuit-level solvers, can be developed.

Given the availability of high-performance EDA software and the affordability of high-performance computing facilities it is possible to construct accurate, precise and reliable models of real-world systems that combine hardware devices and software algorithms. A complete phased array antenna system controlled by codebooks and adaptive algorithms can thus be modelled using EDA tools and its performance can be assessed under various conditions including, for example: operation scenarios; component variation; environmental circumstances; and various use cases. In simplistic terms, each input control variable of the simulation translates to a dimension of the result space or, alternatively, the number dimension of the result space is proportional to the number of inputs. The challenge of such simulations is the interpretation of the results produced. To this end, machine learning techniques and artificial intelligence come to hand.

For example, extensive multi-parameter computer simulations of a phased array antenna system may provide a plethora of simulation results. This training data may be used by the appropriate machine learning techniques—for example unsupervised learning, active learning, reinforcement learning, self-learning, feature learning, sparse dictionary learning, meta learning, federated learning, anomaly detection or association rules—to determine suitable rules that describe a means to represent the relationship between given inputs and wanted outputs without being explicitly programmed. That is, a device such as an aggressor, may perform deep-learning or may implement artificial intelligence to derive or determine information relating to an effectivity of its action may. For example, information about interference it causes (e.g., received reports) may be combined, correlated or associated with information about action it undertakes and with effects achieved thereby (e.g., subsequent reports after having adapted the antenna radiation pattern subsequent to the report).

Deep-learning (including artificial intelligence) may be implemented in more than a single way. For example:
Results of the deep-learning may be obtained as a result of simulations completed during the development and design of the system, e.g., alone and thus without further learning;
Deep-learning may be performed so as to combine the described results of simulations with real-word/in-the-field usage experiences (data collected during usage or operation) in order to further improve the system (through additional learning).

That is, a method for calibrating a device capable of forming an antenna radiation pattern according to an embodiment comprises performing a deep-learning process to evaluate a relationship between a control for forming the antenna radiation pattern and/or a control of sidelobes thereof (target value) on the one hand and information related to the antenna radiation pattern generated de facto (actual value/true value) on the other hand.

Optionally, the obtained information may be updated, e.g., based on further deep-learning, based on the operation of the device.

In addition to the above, the device may be equipped with the means to accept and implement updated look-up-tables (LUTs) that are provided to the device after it is deployed (similar to a software/firmware update). Such updates may be managed and/or distributed by the network through various methods (manually, automatically, scheduled, requested).

Alternatively or in addition, the device (together with the network and other (network/networked devices) may comprise or at least have access to means of providing suitable data in order that deep-learning can be performed outside of the device and/or outside of the network. In effect, other resources are tasked with learning duties thus removing this burden from devices and the network.

The device may be configured for updating, i.e., amending or modifying, a lookup-up table having stored thereon a beam-pattern based on results of the deep-learning or machine learning. Alternatively or in addition, algorithms used by the device may be adapted.

Alternatively or in addition to the aggressor the network, i.e., any entity or a distributed entity such as a network controller or coordinating node may be configured for performing a machine-learning, e.g., using artificial intelligence to consider, evaluate or learn from an effect of controlling the sidelobes on the antenna radiation pattern and to adapt the control of the sidelobes based on the machine-learning.

A level of refinement of a system model obtained thereby, the fidelity of the simulation, the number of swept variables and/or their range and resolution are all design parameters that may affect the accuracy and precision of the simulation results. Again, machine learning techniques may assist one skilled in the art to select these parameters appropriately and thus balance the trade-off between simulation time and performance.

In an example practical realization, the combination of a necessary set of inputs and an appropriate look-up table may enable the required beamforming vectors to be selected quickly and reliably, thus responding dynamically to changes in operational and environmental conditions without the need for time-consuming and iterative adaptions of the phased array excitation.

In the following, additional embodiments and aspects of the invention will be described which can be used individually or in combination with any of the features and functionalities and details described herein.

A first aspect may have a device configured for operating in a wireless communication network, wherein the device is configured for forming an antenna radiation pattern for communicating with a communication partner; wherein the antenna radiation pattern comprises a main lobe, at least one side lobe and a null between the main lobe and the side lobe; wherein the device is configured for controlling the main lobe towards a path to the communication partner; and to control the side lobe and/or the null to address interference at the location of a further device.

According to a second aspect when referring back to the first aspect, the device is configured for transmitting a signal with the antenna radiation pattern or is configured for receiving a signal with the antenna radiation pattern.

According to a third aspect when referring back to the first or second aspect, the device is configured for controlling the side lobes by controlling at least one of a direction of the side lobes and/or of the main lobe thereby affecting the direction of the side lobes; a level of power transfer between the device and the further device by way of the side lobes and/or by use of the main lobe thereby affecting the level of power transfer at the side lobes to the location of the further device; a polarization of the side lobes and/or of the main lobe; a selection of an antenna port used for forming the antenna radiation pattern, of a sub-array of an antenna array used for forming the antenna radiation pattern and/or of at least one antenna panel used for forming the antenna radiation pattern.

According to a fourth aspect when referring back to the first to third aspects, the device is configured for controlling the side lobes by implementing at least one: a phase shift of a signal and between antennas of an antenna array configured for forming the antenna radiation pattern; a change of a frequency of the signal and between antennas of the antenna array; a lengthening or shortening of a transmission line section of a feeding network of the antenna array; a change of a permittivity between the antennas of the antenna array; a change of a permeability between the antennas of the antenna array; and using a power taper for the antenna array.

According to a fifth aspect when referring back to the first to fourth aspects, the device is configured for controlling the side lobes by implementing a phase shift of a signal and between antennas of an antenna array configured for forming the antenna radiation pattern by changing a permittivity between the antennas of the antenna array.

According to a sixth aspect when referring back to the first to fifth aspects, the device is configured for controlling the side lobes by implementing a phase shift of a signal and between antennas of an antenna array configured for forming the antenna radiation pattern by changing a permeability between the antennas of the antenna array.

According to a seventh aspect when referring back to the first to sixth aspects, the device is configured, to address the interference, to control the side lobe in view of a level of power transmission between the device and the further device along at least one path between the device and the further device in a radio propagation environment.

According to an eighth aspect when referring back to the seventh aspect, the communication partner is located as a far device, wherein the further device is located as a near device.

According to a ninth aspect when referring back to the first to eighth aspects, the Signal to Interference Ratio (SIR) is at most a targeted Signal to Interference plus Noise Ratio (SINR) of the link, wherein the device is configured for reducing the interference level to improve the SINR to improve a link capacity between the device and the communication partner.

According to a tenth aspect when referring back to the first to ninth aspects, the device is configured, to address the interference, to control a direction of the sidelobe and/or a direction of a null of the antenna radiation pattern.

According to an eleventh aspect when referring back to the first to tenth aspects, the device is configured for selecting the antenna radiation pattern from a plurality of possible antenna radiation patterns, for generating the antenna radiation pattern and to adapt the generated radiation pattern to reduce the interference between the device and the further device when compared to the selected antenna radiation pattern; or selecting the antenna radiation pattern from a plurality of possible antenna radiation patterns so as to lead to an interference below a predefined interference threshold between the device and the further device; or to a minimum interference between the device and the further device whilst providing for an energy transmission above a predefined transmission threshold between the device and the communication partner or a maximum energy transmission between the device and the communication partner.

According to a twelfth aspect when referring back to the first to eleventh aspects, the device is configured for controlling the sidelobes and/or the antenna radiation pattern based on a codebook and/or based on an adaptive antenna array; wherein the codebook is comprises at least one of a Type I single-panel codebook; a Type I multi-panel codebook; a Type II single-panel codebook; and a Type II multi-panel codebook or a different codebook.

According to a thirteenth aspect when referring back to the first to twelfth aspects, the interference addressed comprises a co-channel interference and/or an adjacent channel interference.

According to a fourteenth aspect when referring back to the first to thirteenth aspects, the device is configured for obtaining knowledge about a location of the further device and/or about at least one direction of a relevant multipath component (MPC) between the device and the further device and for controlling the side lobe to comprise a low amount of power transfer between the device and the location or along the at least one direction so as to address interference.

According to a fifteenth aspect when referring back to the first to fourteenth aspects, the device is configured for obtaining knowledge about a request to reduce interference at the location of the further device based on a report of the further device or based on instructions received from the wireless communication network.

According to a sixteenth aspect when referring back to the first to fifteenth aspects, the device is configured for receiving directly or indirectly a reporting about a measure of interference

According to a seventeenth aspect when referring back to the first to sixteenth aspects, the report is based on a reception of wireless energy transmitted by the device; and/or predictive based on a location or movement of the device.

According to an eighteenth aspect when referring back to the first to seventeenth aspects, wherein the device is configured for controlling a plurality of side lobes of the antenna radiation pattern so as to address interference at a plurality of locations.

According to a nineteenth aspect when referring back to the first to eighteenth aspects, the device is configured, for addressing the interference to the further device and another device, for controlling at least a first and a second sidelobe of the antenna radiation pattern based on a sidelobe-by-sidelobe assessment.

According to a twentieth aspect when referring back to the first to nineteenth aspects, the device comprises an antenna arrangement and is configured for performing beamforming with the antenna arrangement.

According to a twenty-first aspect when referring back to the first to twentieth aspects, the device is configured for receiving, from the further device, a signal indicating an exchange of energy or an observation of received power between the device and the further device.

According to a twenty-second aspect when referring back to the first to twenty-first aspects, the device is configured for performing a beemsweeping procedure to address the interference in which the antenna radiation pattern is at least in parts moved in space.

According to a twenty-third aspect when referring back to the first to twenty-second aspects, the device is configured for implementing a blanking/puncturing/power boosting pattern to the antenna radiation pattern by which punctured/blanked/power boosted resources of the antenna radiation pattern are made specifically observable at the location of the further device via a multipath propagation environment at least partially to address the interference.

According to a twenty-fourth aspect when referring back to the a twenty-third aspect, the blanking/puncturing/power boosting pattern is associated with an identity of the device.

According to a twenty-fifth aspect when referring back to the first to twenty-fourth aspects, the further device is not a member of the wireless communication network.

According to a twenty-sixth aspect when referring back to the first to twenty-fifth aspects, the device performs, responsive to having acquired information about a request to reduce interference at the location of the further device at least one of: a renegotiation between devices forming a link in which the device is one part of that link, advantageously by adapting the antenna pattern of the transmitting devices and/or that of the receiving device; a pattern restriction of the antenna radiation characteristic in direction/coverage/illumination, e.g., when the device is a drone flying over a base transceiver station (BTS) or when the device is a vehicle in a tunnel or when the device is a possibly low-earth orbiting satellite that communicates with a terrestrial device as communication partner or vice versa; a goal-based or target-based action, e.g. to reduce power affecting the further device, reschedule and/or coordinate beams of selected transmit antenna pattern; a command-based action, e.g. to use beam X when condition Y, or do not use beam P when condition Q; to use selective code book entries or beam indices.

According to a twenty-seventh aspect when referring back to the first to twenty-sixth aspects, the device is a base station configured for operating a cell of the wireless communication network or a UE operating in the cell.

According to a twenty-eighth aspect when referring back to the nineteenth to twentieth aspects, the device is configured for receiving the report from the further device as a device of the wireless network in which the device operates.

According to a twenty-ninth aspect when referring back to the first to twenty-eighth aspects, the device is configured for performing a machine-learning to consider an effect of controlling the sidelobes on the antenna radiation pattern; and to adapt the control of the sidelobes based on the machine-learning.

A thirtieth aspect has a device configured for operating in a wireless communication network, wherein the device is configured for communicating with a communication partner;
wherein the device is configured for determining a measure of interference associated with a further device not communicating with the device and for reporting, to the further device or a member of its communication network about the reception of power or interference from the further device.

According to a thirty-first aspect when referring back to the twenty-fifth aspect, the device is configured for forming an antenna radiation pattern.

According to a thirty-second aspect when referring back to the thirtieth or thirty-first aspect, the device is configured for determining the measure of interference based on a reception of wireless energy transmitted by the further device; and/or predictive based on a location or movement of at least one of the further device, a communication partner of the further device and the device.

According to a thirty-third aspect when referring back to the thirtieth to thirty-second aspects, the device is configured for determining at least a part of an antenna radiation characteristic of the further device and for reporting about the measure of interference so as to report about the at least part of the antenna radiation characteristic.

According to a thirty-fourth aspect when referring back to the thirtieth to thirty-third aspects, the device is configured for reporting to the further device about the reception via a feedback channel or a control channel of the same or a different network.

According to a thirty-fifth aspect when referring back to the thirtieth to thirty-fourth aspects, the device is configured for reporting to the further device about the reception based on at least one of a Cell Identification (ID) of a cell of a wireless network; a beam characteristic/identification; a localization or geolocation; a power class; a sounding reference symbol (SRS); a synchronization signal block (SSB); a channel state information reference signal (CSI RS); a bandwidth part (BWP); a blanking/puncturing/boosting pattern; and RS and/or data transmitted from interfering source to be used as pseudo RS.

According to a thirty-sixth aspect when referring back to the thirtieth to thirty-fifth aspects, the device is configured for qualifying/quantifying/classifying/categorizing the reception of wireless energy transmitted by the further device based on at least one of: a signal-to-interference-plus-noise ratio (SINR) degradation; a signal-to-interference (SIR) ratio; an interference level; a hybrid automatic repeat request (HARQ) acknowledgement (ACK) or negative ACK (NACK); an SINR/SIR level analysis, e.g., per (HARQ) retransmission packet or per receive beam pattern; an SIR/SINR margin with respect to a targeted SINR; and an SINR margin with adaptive beamforming considering reception (RX) nulling.

According to a thirty-seventh aspect when referring back to the thirtieth to thirty-sixth aspects, the device is configured for quantifying and/or qualifying the further device as a source of interference based on at least one of: Parameterization of potential aggressor characteristics; Time slot, resource grid, assigned channel, BWP; SRS, SSB, CSI RS; Direction; Polarization; Operating frequency, channel assignment; Direction of transmission being uplink or downlink; Observed blanking/puncturing/power boosting pattern.

According to a thirty-eighth aspect when referring back to the twenty-fifth to thirty-second aspects, the device is configured for reporting the reception based on at least one of: a full set, a sub-set, a compressed/reduced set of parameters; and an incremental, differential, event-based and/or an ordered list.

According to a thirty-ninth aspect when referring back to the thirtieth to thirty-eighth aspects, the device is configured for reporting the reception based on at least one of: trigger/threshold based/event based; upon request; timed; synchronized; queued; trailing/lagging/windowing (last×minutes); and hint about masking/interrupts; calibrated/authorized/verified/certified/“type approved”.

According to a fortieth aspect when referring back to the thirtieth to thirty-seventh aspects, the device is configured for reporting about the reception directly to the further device or to the wireless communication network.

According to a forty-first aspect when referring back to the thirtieth to fortieth aspects, the further device is not a member of the wireless communication network.

According to a forty-second aspect when referring back to the forty-first aspect, the device is configured for reporting to the further device about the reception indirectly by reporting to an entity of the wireless network to forward the report and/or to an entity of a further network in which the further device is a member so as to trigger countermeasures.

According to a forty-third aspect when referring back to the forty-second aspect, the wireless communication network and the further wireless communication network communicate with each other as one includes one of: geographically co-located networks of a same or different Mobile Network Operator (MNO) including fixed wireless access (FWA) networks, private networks, integrated access and backhaul (IAB) networks, e.g., in half-duplex or full-duplex; non-terrestrial network to terrestrial network; maritime network to terrestrial network; maritime network to non-terrestrial networks; and any possible combination of the above.

A forty-forth aspect may have a wireless communication network comprising: at least one interfering device according to the first to twenty-ninth aspects, to cause interference; and at least one interfered device according to the thirtieth to fortieth aspects.

According to a forty-fifth aspect when referring back to the forty-fourth aspect, the interfering device is configured for addressing the interference in a link between at least one of: a base station and a user equipment, UE; a base station and a backhaul entity; a base station and a relay entity; a first relay entity and a second relay entity; a relay entity and further infrastructure; a first base station and a second base station; a first UE and a second UE; a UE and a further infrastructure; and a UE and a relay entity.

According to a forty-sixth aspect when referring back to the forty-fourth or forty-fifth aspect, the interfering device is configured for addressing the interference affecting a link operated between a device communicating with the interfered device and the interfered device communicating with a communication partner by at least one of: applying interference mitigation/avoidance measure e.g. using of appropriate antenna radiation pattern; always or in a coordinated/synchronized manner at least when the victim is scheduled to receive information from its communication partner; and/or allowing the victim to successfully listen to control channels of the communication partner e.g. provision of grants for future messages to/from the victim.

According to a forty-seventh aspect when referring back to the forty-fourth or forty-sixth aspects, the network or an entity thereof is configured for performing a machine-learning to consider an effect of controlling the sidelobes on the antenna radiation pattern; and to adapt the control of the sidelobes based on the machine-learning.

A forty-eighth aspect may have a method for operating a device in a wireless communication network, the method comprising: forming an antenna radiation pattern for communicating with a communication partner, such that the antenna radiation pattern comprises a main lobe and, at least one side lobe and a null between the main lobe and the side lobe; controlling the main lobe towards a path to the communication partner; controlling the side lobe and/or the null to address interference at the location of a further device.

A forty-ninth aspect may have a method for operating a device in a wireless communication network, wherein the device is configured for communicating with a communication partner, the method comprising: determining a measure of interference associated with a further device not communicating with the device; reporting, to the further device or a member of its communication network about the reception of power or interference from the further device.

A fiftieth aspect may have a method for calibrating a device capable of forming an antenna radiation pattern, the method comprising: performing a deep-learning process to evaluate a relationship between a control for forming the antenna radiation pattern and/or a control of sidelobes thereof on the one hand and information related to the antenna radiation pattern generated de facto; and storing information obtained based on the deep-learning in a non-volatile data storage of an entity wireless communication network or of the device.

According to a fifty-first aspect when referring back the fiftieth aspect, the method further comprises: updating the stored information based on an operation of the device.

A fifty-second aspect may have a computer readable digital storage medium having stored thereon a computer program having a program code for performing, when running on a computer, a method according to the forty-eighth to fifty-first aspects.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

1. Rebato, M., Mezzavilla, M., Rangan, S., Boccardi, F., and Zorzi, M., “Understanding Noise and Interference Regimes in 5G Millimeter-Wave Cellular Networks,” European Wireless 2016, 22^{nd} European Wireless Conference, Oulu, Finland, 2016, pp. 1-5
2. “Enhancing LTE Cell-Edge Performance via PDCCH ICIC”, White Paper, Fujitsu Network Communications, Inc., USA, 2011
3. Atteya, N., Maximov, S., and El-saidny, M., “5G NR: A New Era for Enhanced Mobile Broadband”, White Paper, MediaTek, Inc., 2018
4. “Field Testing in 5G NR”, White Paper, Keysight Technologies, Inc., USA, 2018
5. Bertenyi, B., Nagata, S., Kooropaty, H., Zhou, X., Chen, W., Kim, Y., Dai, X., and Xu, X., “5G NR Radio Interface”, Journal of ICT, Vol. 6 1&2, 31-58. River Publishers, May 2018
6. 3GPP R1-1810108, “Beam measurement and report using L1-RSRQ or SINR”, Huawei and HiSilicon, 3GPP TSG RAN WG1 Meeting #94bis, Chengdu, China
7. 3GPP TR 38.802, “Study on New Radio Access Technology: Physical Layer Aspects”, V14.2.0 (2017 September)
8. Hubregt J. Wisser, “Array and Phased Array Antenna Basics”, Wiley, Chichester, 2005
9. R. C. Johnson (ed.), “Antenna Engineering Handbook”, 3^{rd} Ed., McGraw-Hill, New York, 1993
10. Merill I. Skolnik, “Introduction to Radar Systems”, 2^{nd} Ed., McGraw-Hill, Auckland, 1981
11. Randy Haupt, “Antenna Arrays: A computational Approach”, Wiley, 2010
12. J. Wang et al., “Beamforming Codebook Design and Performance Evaluation for 60 GHz Wideband WPANs”, 2009 IEEE 70th Vehicular Technology Conference Fall, Anchorage, AK, 2009, pp. 1-6
13. Sassan Ahmadi, “5G NR”, Elsevier, 2019

1. A device configured for operating in a wireless communication network, wherein the device is configured for forming an antenna radiation pattern for communicating with a communication partner;
wherein the antenna radiation pattern comprises a main lobe, at least one side lobe and a null between the main lobe and the side lobe;
wherein the device is configured for controlling the main lobe towards a path to the communication partner; and to control a direction of the side lobe and/or to control the null to address interference at the location of a further device.

2. The device of claim 1, wherein the device is configured for transmitting a signal with the antenna radiation pattern or is configured for receiving a signal with the antenna radiation pattern.

3. The device of claim 1, wherein the device is configured for controlling the side lobes by controlling at least one of
a direction of the side lobes and/or of the main lobe thereby affecting the direction of the side lobes;
a polarization of the side lobes and/or of the main lobe;
a selection of an antenna port used for forming the antenna radiation pattern, of a sub-array of an antenna array used for forming the antenna radiation pattern and/or of at least one antenna panel used for forming the antenna radiation pattern.

4. The device of claim 1, wherein the device is configured, to address the interference, to control the side lobe in view of a level of power transmission between the device and the further device along at least one path between the device and the further device in a radio propagation environment.

5. The device of claim 4, wherein the communication partner is located as a far device, wherein the further device is located as a near device.

6. The device of claim 1, being configured, to address the interference, to control the direction of the sidelobe and/or a direction of the null of the antenna radiation pattern.

7. The device of claim 1, wherein the device is configured for selecting the antenna radiation pattern from a plurality of possible antenna radiation patterns, for generating the antenna radiation pattern and to adapt the generated radiation pattern to reduce the interference between the device and the further device when compared to the selected antenna radiation pattern; or
selecting the antenna radiation pattern from a plurality of possible antenna radiation patterns so as to lead to an interference below a predefined interference threshold between the device and the further device; or to a minimum interference between the device and the further device whilst providing for an energy transmission above a predefined transmission threshold between the device and the communication partner or a maximum energy transmission between the device and the communication partner.

8. The device of claim 1, wherein the device is configured for controlling the sidelobes and/or the antenna radiation pattern based on a codebook and/or based on an adaptive antenna array; wherein the codebook comprises at least one of a Type I single-panel codebook; a Type I multi-panel codebook; a Type II single-panel codebook; and a Type II multi-panel codebook or a different codebook.

9. The device of claim 1, wherein the device is configured for acquiring knowledge about a location of the further device and/or about at least one direction of a relevant multipath component between the device and the further device and for controlling the side lobe to comprise a low amount of power transfer between the device and the location or along the at least one direction so as to address interference.

10. The device of claim 1, wherein the device is configured for acquiring knowledge about a request to reduce interference at the location of the further device based on a report of the further device or based on instructions received from the wireless communication network.

11. The device of claim 1, wherein the device is configured for receiving directly or indirectly a reporting about a measure of interference

12. The device of claim 11, wherein the reporting is based on a reception of wireless energy transmitted by the device; and/or predictive based on a location or movement of the device.

13. The device of claim 11, wherein the device is configured for receiving the reporting from the further device as a device of the wireless network in which the device operates.

14. The device of claim 1, wherein the device is configured for controlling a plurality of side lobes of the antenna radiation pattern so as to address interference at a plurality of locations.

15. The device of claim 1, wherein the device is configured, for addressing the interference to the further device and another device, for controlling at least a first and a second sidelobe of the antenna radiation pattern based on a sidelobe-by-sidelobe assessment.

16. The device of claim 1, wherein the device is configured for performing a beemsweeping procedure to address the interference in which the antenna radiation pattern is at least in parts moved in space.

17. The device of claim 1, wherein the device performs, responsive to having acquired information about a request to reduce interference at the location of the further device at least one of:
a renegotiation between devices forming a link in which the device is one part of that link, preferably by adapting the antenna pattern of the transmitting devices and/or that of the receiving device;
a pattern restriction of the antenna radiation characteristic in direction/coverage/illumination, e.g., when the device is a drone flying over a base transceiver station or when the device is a vehicle in a tunnel or when the device is a possibly low-earth orbiting satellite that communicates with a terrestrial device as communication partner or vice versa;
a goal-based or target-based action, e.g. to reduce power affecting the further device, reschedule and/or coordinate beams of selected transmit antenna pattern;
a command-based action, e.g. to use beam X when condition Y, or do not use beam P when condition Q;
to use selective code book entries or beam indices.

18. The device of claim 1, wherein the device is a base station configured for operating a cell of the wireless communication network or a UE operating in the cell.

19. Method for operating a device in a wireless communication network, the method comprising:
forming an antenna radiation pattern for communicating with a communication partner, such that the antenna radiation pattern comprises a main lobe and, at least one side lobe and a null between the main lobe and the side lobe;
controlling the main lobe towards a path to the communication partner;
controlling a direction of the side lobe and/or controlling the null to address interference at the location of a further device.

20. A non-transitory digital storage medium having a computer program stored thereon to perform the method for operating a device in a wireless communication network, the method comprising:
forming an antenna radiation pattern for communicating with a communication partner, such that the antenna radiation pattern comprises a main lobe and, at least one side lobe and a null between the main lobe and the side lobe;
controlling the main lobe towards a path to the communication partner;
controlling a direction of the side lobe and/or controlling the null to address interference at the location of a further device,
when said computer program is run by a computer.
